(19) United States
(12) Patent Application Publication
(10) Pub. No.: US 2007/0154169 A1
(43) Pub. Date: Jul. 5, 2007

(54) Systems and methods for accessing media program options based on program segment interest

(75) Inventors: Charles Cordray, New York, NY (US); Samir B. Armaly, La Canada, CA (US)

Correspondence Address: FISH & NEAVE IP GROUP;ROPES & GRAY LLP, 1211 AVENUE OF THE AMERICAS, NEW YORK, NY, 10036-8704, US

(73) Assignee: United Video Properties, Inc.

(21) Appl. No.: 11/324,184

(22) Filed: Dec. 29, 2005

(51) Int. Cl. H04N 5/91

(52) U.S. Cl. 386/83

(57) ABSTRACT

The disclosed technology provides systems and methods for maintaining a user's interest level in a media program by allowing a user to access particular segments of interest from a media program. A media program can have logical segments, and the disclosed technology can identify the segments of the media program. A user can designate particular segments of interest from the segments of the media program and can be provided with only the designated segments.

### BACKGROUND OF THE INVENTION

The disclosed technology relates generally to user interest in media programs and, more particularly, to gathering information on user interest with respect to portions of particular media programs.

Television program and other media program offerings today are vast and continue to grow in quantity and diversity. With the advent of interactive program guides and other media navigation applications, audiences now have the ability to navigate among the growing media program offerings more easily than before. For example, a program guide may allow a user to enjoy one media program while browsing through program descriptions of other media programs. Therefore, audience members can more easily navigate media program listings to pass time during commercials or to find other, more interesting programs. Accordingly, through greater ease of navigation, audiences may have a greater ability to find and view programs of interest.

Audiences also continue to have the ability to record programs for later enjoyment at their convenience and at their own pace. For example, traditional recording devices such as VCRs continue to be in use, and emerging recording devices based on hard disks and writable optical disks (e.g., CDs and DVDs) are gradually gaining their share of the marketplace. These recording devices allow busy audience members to enjoy media programs that they would otherwise have missed. Additionally, they allow audience members to control the playback of the media program based on their interest level. For example, users can pause the recording if they are interrupted during an interesting portion, rewind the recording over an especially important or enjoyable portion, or fast-forward the recording through an uninteresting portion (e.g., a commercial). Accordingly, by using a recording device, audiences can have the ability to control the presentation of a media program based on their level of interest.

Given the vast selection of media program offerings and the increasing ability of users to find other interesting programs and to control program presentation, programming stations may have a more difficult time attracting and maintaining audiences. Accordingly, there is continuing interest in developing and improving ways to maintain an audience member's level of interest in particular media programs.

### SUMMARY OF THE INVENTION

The disclosed technology relates to maintaining a user's interest level in media programs by monitoring and using a user's interests in particular segments of media programs to provide users with different media program versions or options. The media program segments referred to herein may be logical or physical segments. In one aspect of the invention, systems and methods are provided for using a user's interests in particular segments of media programs to determine what media content may be of interest to the user.

In one aspect of the invention, the disclosed systems and methods can use a user's interests in segments of a particular media program to determine whether or not to record episodes of the particular media program. For example, in accordance with one aspect of the invention, the disclosed systems may know that a user consistently watches the Late Show with David Letterman, but does not watch the entire show. Rather, the user may watch only the Top Ten List and then turn off the television or switch to another channel. Based on knowing this preference, the disclosed systems and methods can, in one embodiment, record the Top Ten List segment of the Late Show if the user is not available to catch an episode. In another example, the user may consistently watch the entire Late Show with David Letterman. In this case, the disclosed technology can record the entire Late Show if the user is not available to catch an episode.

In one aspect of the invention, the disclosed systems and methods can use a user's interests in segments of a particular media program to determine which types of content or which media program options to present to a user. In one example, if a user typically stays tuned through the entire course of a program, the user may be the kind of audience member who would be interested in accessing an extended version of that program. For example, if a user consistently watches the entire program of the Late Show with David Letterman, the disclosed technology may present such user with an option to view an extended version of the Late Show with out-takes. On the other hand, if a user typically stays tuned only through select segments of a particular media program, the user may be the kind of audience member who would be interested in accessing only particular segments of the media program or only a condensed version (e.g., a summary or highlight version) of the media program. For example, if a user typically watches portions of the Late Show with David Letterman but does not watch the entire show, the disclosed technology may in one embodiment present such user with a summary version of the show that includes a text description of the show, for example, or present such user with a highlight version of the show that includes video snapshots of portions of the show, for example. In one embodiment, the disclosed technology may present the user with the option to watch only those portions of the Late Show that the user usually watches. In this manner, the disclosed systems and methods can suggest, present, or record for a user those media program versions or segments that he or she may enjoy.

In one aspect of the invention, the disclosed systems and methods can monitor a user's interest in segments of one particular media program and use that information to suggest, present, or record for the user analogous or relevant portions of other media programs. For example, many different television channels have sports-related media programs, such as FOX Sports or ESPN Sportscenter, for example, and the different sports-related media programs may have analogous or relevant segments. For example, ESPN Sportscenter may have a Top Plays segment which features clips of recent, particularly enthralling sports plays. Additionally, FOX Sports can also include a Top Plays segment. In accordance with one aspect of the invention, if a user typically watches the Top Plays segment of ESPN Sportscenter, the disclosed technology can suggest, present, or record for the user the Top Plays segment of Fox Sports. In one embodiment, the Top Plays segment of Fox Sports can be presented to the user when the user accesses Fox Sports. In one embodiment, the Top Plays segment of Fox Sports can be presented to the user even when the user may not have accessed Fox Sports. In this embodiment, the disclosed technology can seek out other media programs that have a Top Plays segment analogous to the Top Plays segment in ESPN Sportscenter and can find the Fox Sports media program in that manner.

In one aspect of the invention, the disclosed technology can also monitor a user's interest in segments of commercials. A commercial may include one segment or multiple segments. Different commercials may be analogous or may be relevant to each other or may have analogous or relevant segments. In one embodiment, the disclosed technology can use a user's interest in segments of commercials to determine which commercials to record and which commercial to not record. For example, if a user typically watches BMW car commercials but does not watch Mercedes car commercials, the disclosed technology can record BMW commercials but not record Mercedes commercials. In one embodiment, the disclosed technology can use a user's interest in segments of commercials to select commercials to present to a user. Continuing with the car commercial example, the disclosed technology can select more BMW car commercials to present to the use based on knowing that the user watches BMW commercials.

In one aspect of the invention, the disclosed systems and methods can associate different business models with media program versions or options that are presented to a user. For example, in one exemplary business model, a user can access a regular version of a media program at no additional charge but may be assessed a particular charge for accessing a commercial-free version of the media program and assessed another charge for accessing an extended version of the media program.

In one aspect of the invention, media programs can have logical segments, and user equipment can monitor user interest with respect to particular media program segments. In one embodiment, if there is about the same interest in all of the segments of a media program, it may be appropriate to present the user with an option to access an extended version of the media program. On the other hand, if there is more interest in some segments and less interest in other segments, it may be appropriate to present the user with an option to access a condensed version of the media program. In another example, if there is much more interest in particular segments than in other segments, it may be appropriate to present the user with an option to manually designate particular segments to access/record and the segments to not access/record.

In one embodiment, a user can select to access or record a media program from an interactive program guide. In accordance with one aspect of the invention, the interactive program guide can determine whether or not different versions of a selected program are available, or if extra options for the program are available. If they are available, the interactive program guide can determine which of the versions or options are appropriate for the user based on the user's interest in the media program's segments. A user who is presented with the opportunity to access the different versions or options can select to access one of the versions or options through the interactive program guide. In one embodiment, if the interactive program guide is a networked program guide and is in communication with different types of user devices, the interactive program guide can access the separate segment interest information for the different devices. Therefore, the interactive program guide may know that viewing habits on different devices may be different and may provide different media program versions or options to different devices.

In one aspect of the invention, the disclosed systems and methods can provide media program options to a user based on a community's interest in the media program's segments. In this manner, a user may be able to sample and access media program options that may be enjoyed by the community as a whole.

Further features of the invention, its nature and various advantages, will be more apparent from the accompanying drawings and the following detailed description of the various embodiments.

### BRIEF DESCRIPTION OF THE DRAWINGS

FIG. 1 is a diagram of an exemplary display screen for setting an opportunity to access alternative versions of television programs;

FIG. 2 is a display screen of an exemplary media program;

FIG. 3 is a display screen of an exemplary interactive program guide;

FIG. 4 is a diagram of an exemplary display interface for accessing recorded/stored programs;

FIG. 5 is a diagram of an exemplary display screen presenting an option to access an extended version of a media program;

FIG. 6 is a diagram of an exemplary display screen presenting options to access condensed versions of a media program;

FIG. 7 is a diagram of an exemplary display interface for designating segments of a media program to access and segments of a media program to not access;

FIG. 8 is a block diagram of exemplary media program segments;

FIG. 8A is a diagram of an exemplary display screen presenting options to view favorite segments of a media program;

FIG. 8B is a diagram of an exemplary display screen presenting options to view an extended version of a media program;

FIG. 8C is a diagram of an exemplary display screen;

FIG. 8D is a diagram of an exemplary display screen of a media segment selection menu that may be displayed in response to selection of a media program in FIG. 8C;

FIG. 8E is a diagram of an exemplary display of a media segment recommendation screen;

FIG. 9 is a diagram of an exemplary segment information data structure;

FIG. 10 is a block diagram of exemplary components in a segment tune-in timer circuit;

FIG. 11 is a flow diagram of exemplary operations of the segment tune-in timer circuit of FIG. 10;

FIG. 12 is a flow diagram of exemplary operations for computing a tune-in duration;

FIG. 13 is a flow diagram of exemplary operations of the segment tune-in timer circuit of FIG. 10 in connection with presentation control commands;

FIG. 14 is a diagram of an exemplary segment interest table;

FIG. 15 is a diagram of an exemplary segment interest table having longer term interest information and shorter term interest information;

FIG. 16 is a diagram of an exemplary community segment interest table that receives interest information from a plurality of user equipment;

FIG. 17 is a block diagram of an exemplary program options circuit for presenting options to access different program versions;

FIG. 18 is a flow diagram of exemplary operations of the program options circuit of FIG. 17;

FIG. 19 is a flow diagram of exemplary operations of the program options circuit of FIG. 17 in connection with providing an option to access a condensed version of a related program from an earlier time slot;

FIG. 20 is a diagram of an exemplary display screen for presenting options to access alternative versions of a media program with commercials and without commercials;

FIG. 21 is a diagram of an exemplary segment interest table that includes interest information for commercials;

FIG. 21A is a diagram of an exemplary display screen showing media alternatives in accordance with a business model;

FIG. 21B is a diagram of a exemplary display screen showing media alternative in accordance with an alternative business model;

FIG. 22 is a diagram of an exemplary media guidance system in accordance with one aspect of the invention;

FIG. 23 is a diagram of exemplary user television equipment in the media guidance system of FIG. 22;

FIG. 24 is a diagram of exemplary user recording equipment in the media guidance system of FIG. 22;

FIG. 25 is a diagram of an exemplary remote control device;

FIG. 26 is a diagram of exemplary user computer equipment in the media guidance system of FIG. 22; and

FIG. 27 is a diagram of exemplary user equipment in the media guidance system of FIG. 22.

### DETAILED DESCRIPTION OF THE PREFERRED EMBODIMENTS

The amount of media available to users in any given media delivery system can be substantial. Consequently, many users desire a form of media guidance, an interface that allows users to efficiently navigate media selections and easily identify media that they may desire. An application which provides such guidance is referred to herein as an interactive media guidance application or, sometimes, a guidance application.

Interactive media guidance applications may take various forms depending on the media for which they provide guidance. One typical type of media guidance application is an interactive television program guide. Interactive television program guides are well-known guidance applications that, among other things, allow users to navigate among and locate television programming viewing choices and, in some systems, digital music choices. The television programming (and music programming) may be provided via traditional broadcast, cable, satellite, Internet, or any other means. The programming may be provided on a subscription basis (sometimes referred to as premium programming), as pay-per-view programs, or on-demand such as in video-on-demand (VOD) systems.

With the advent of the Internet, mobile computing, and high-speed wireless networks, users are able to access media on personal computers (PCs) and devices on which they traditionally could not. Non-television-centric platforms (i.e., platforms that distribute media with equipment not part of the user's broadcast, cable or satellite television-delivery network) allow users to navigate among and locate desirable video clips, full motion videos (which may include television programs), images, music files, and other suitable media. Consequently, media guidance is also necessary on modern non-television-centric platforms. For example, media guidance applications may be provided as on-line applications (i.e., provided on a web-site), or as stand-alone applications or clients on hand-held computers, personal digital assistants (PDAs) or cellular telephones. In some systems, users may control equipment remotely via a media guidance application. For example, users may access an online media guide and set recordings or other settings on their in home equipment. This may be accomplished by the on-line guide controlling the user's equipment directly or via another media guide that runs on the user's equipment. Remote access of interactive media guidance applications is discussed in greater detail in U.S. patent application Ser. No. 11/246,392, filed Oct. 7, 2005, which is hereby incorporated by reference herein in its entirety.

The present invention relates generally to media programs and can also relate to media programs identified through a media guidance application, such as a television program guide. The aspects and embodiments of the invention described herein can be provided through an interactive program guide. One aspect of the disclosed technology relates to maintaining a user's interest level in a media program by monitoring a user's interests in particular media program segments. Based on knowing the user's interests in particular media program segments, the disclosed technology can suggest, present, or record media content that a user may enjoy.

For example, if a user typically stays tuned through the entire course of a particular program, the user may be interested in all segments of the program and, further, may be interested in accessing an extended version of the media program. On the other hand, if a user typically stays tuned only through select segments of a media program, the user may only be interested in accessing particular segments of the media program or only a condensed version (e.g., a summary or highlight version) of the media program.

In another example, the disclosed technology can monitor a user's interest in segments of a particular media program and suggest, present, or record for the user analogous or relevant segments of other media programs. For example, if a user typically watches a Top Plays segment of a sports program, such as ESPN Sportscenter, the disclosed technology can suggest, present, or record for the user an analogous Top Plays segment of another sports program, such as FOX Sports.

In some embodiments where a user device is largely used by a single user (such as a cellular telephone), it may be possible to accurately determine a single user's interest in particular media program segments. However, in embodiments where a user device is used by multiple users (such as a home television), it may be more difficult to discern each individual user's interest in particular media program segments. Rather, in such embodiments, the disclosed technology may monitor a group's interest in particular media program segments. From hereon, the term “user interest” will be used to refer to interest for a single user device. In contrast, the term “community interest” will be used to refer to an accumulation of user interest from multiple user devices. In some embodiments of the present invention, users may choose to belong to one or more communities, including, without limitation, a science fiction community, a “family oriented” community, and a sports community. Other communities are also contemplated.

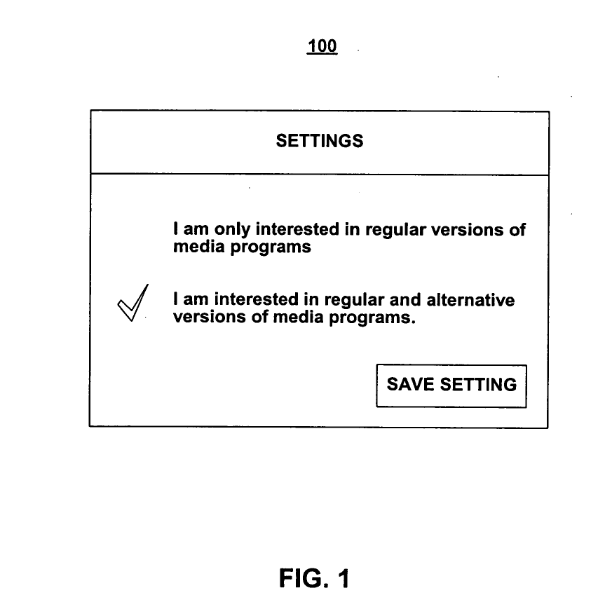

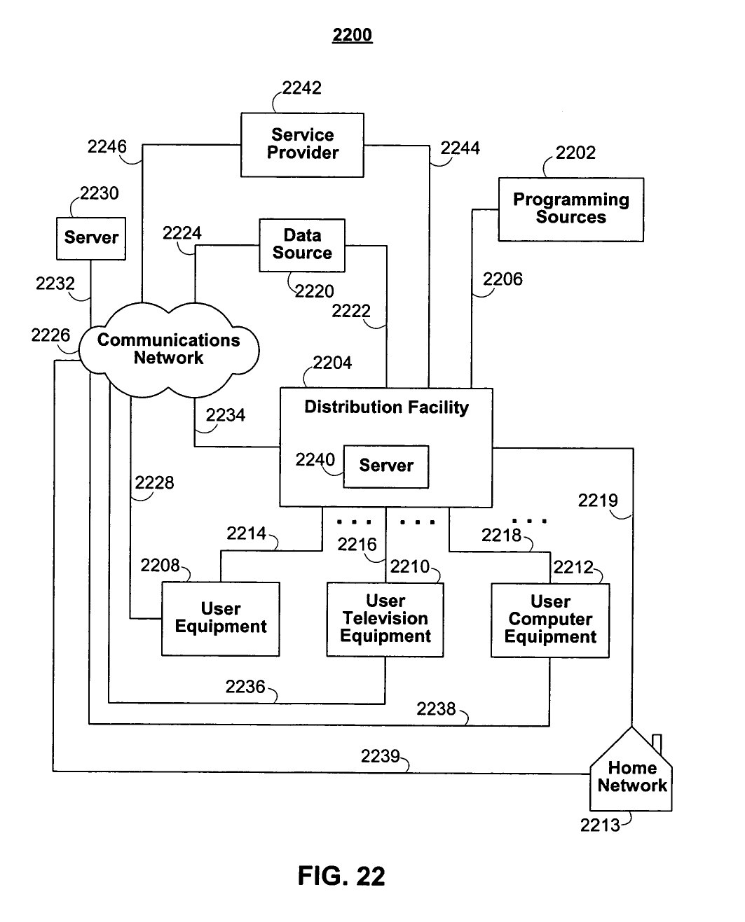

Referring now to FIG. 1 and in accordance with one aspect of the invention, there is shown an exemplary display screen 100 which contains settings that allow a user to specify whether he or she is interested in accessing only regular versions of media programs or regular and alternative versions of media programs. The illustrated display screen 100 can apply to user equipment that can access and/or present media programs, including, but not limited to, television equipment, computer equipment, mobile computing equipment (e.g., laptop, pocket PC, PDA, cellular telephone), and other mobile or portable television viewing devices, such as location-free television consumer electronic devices or car entertainment systems that include a television tuner. User equipment and their interactions with surrounding networks will be described in more detail later herein in connection with FIGS. 22-27.

As shown in FIG. 1, there is a setting which allows the system to provide a user with access to regular and alternative versions of media programs. As used herein, the term “regular version” may have different meanings for different media platforms. In a broadcast platform, a “regular version” can refer to the broadcast version of a media program, so that user equipment tuning in to the broadcast would receive the “regular version” of the media program. In a non-broadcast platform, a “regular version” of a media program can refer to a media program version that would generally be provided to requesting user equipment. For example, when different user equipment access the CNN website, the same webpage will generally be provided to the user equipment; that same webpage is referred to herein as the “regular version.” As used herein, the term “alternative version” refers to a media program that is related to the regular version of a media program but that is not identical to the regular version. For example, a alternative version of a media program can include some segments from the media program but not other segments. As another example, an alternative version of a media program can include a text summary of the media program or an extended version of the media program with additional content. Additionally, as used herein, the term “different versions” can refer to multiple, related versions of a media program. For example, different versions of a media program may refer to a regular version and an alternative version of a media program, or may refer to multiple alternative versions of a media program.

From hereon, the following detailed description may refer to media programs without referring to whether the platform is a broadcast platform, a non-broadcast platform, or otherwise. Unless provided otherwise, it is contemplated that the aspects and embodiments described herein are applicable to broadcast, non-broadcast, and other types of platforms.

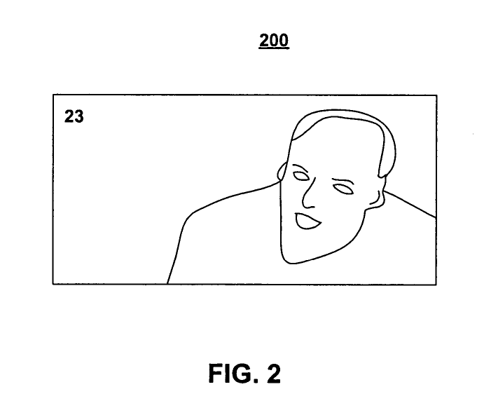

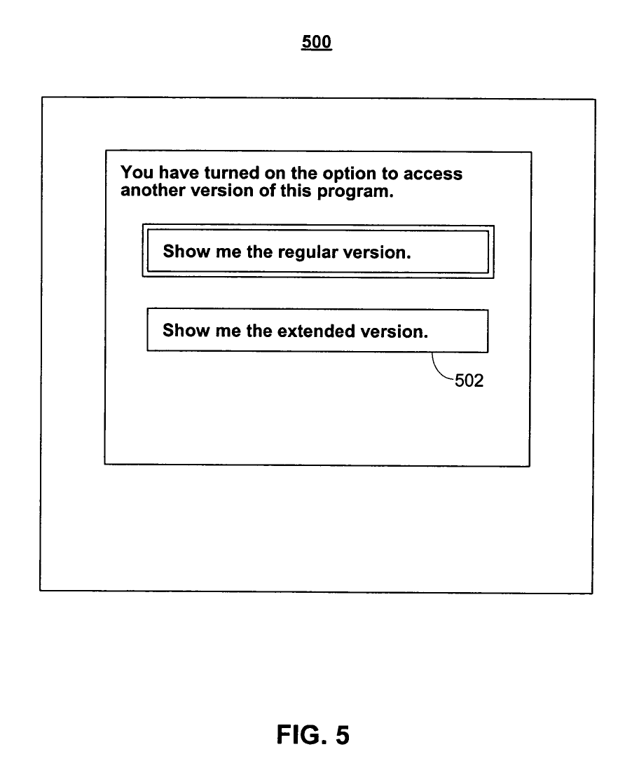

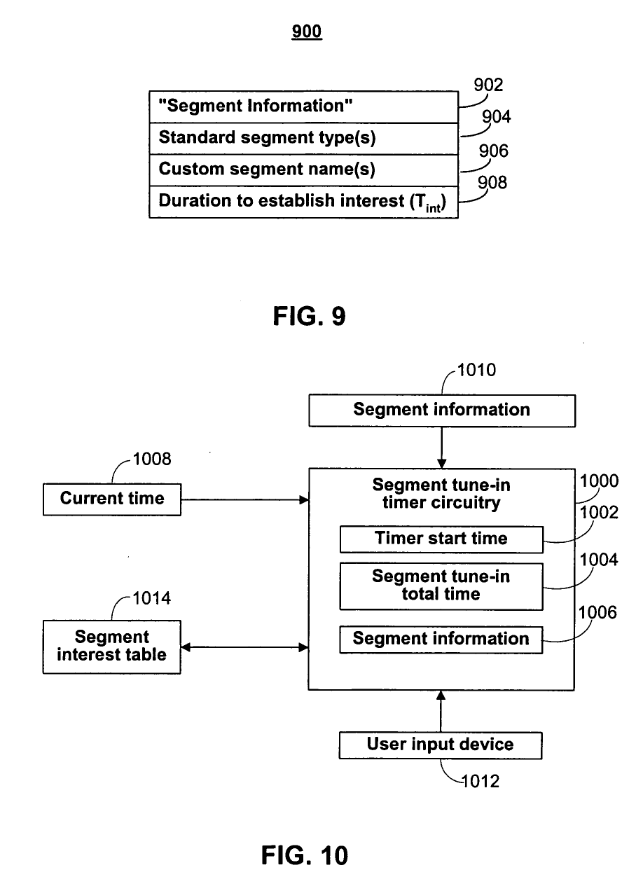

FIGS. 2-4 show exemplary ways by which a user can access a media program for viewing or for recording. FIG. 2 shows a display screen 200 that is presenting a media program. The media program can be received from a broadcast signal, received from an on-demand or other communication channel, or accessed from a local storage device. A user can use an interface device, such as a remote control, to change channels or to control the presentation of the program (e.g., fast-forward, rewind). In accordance with one aspect of the invention, the disclosed technology can monitor a user's interest in the segments of the media program on the display screen 200. This monitoring is described in more detail in connection with FIGS. 9-15. Additionally, from the illustrated display screen 200, the disclosed technology can also present a user with media program options, which will be described in more detail in connection with at least FIGS. 5-7.

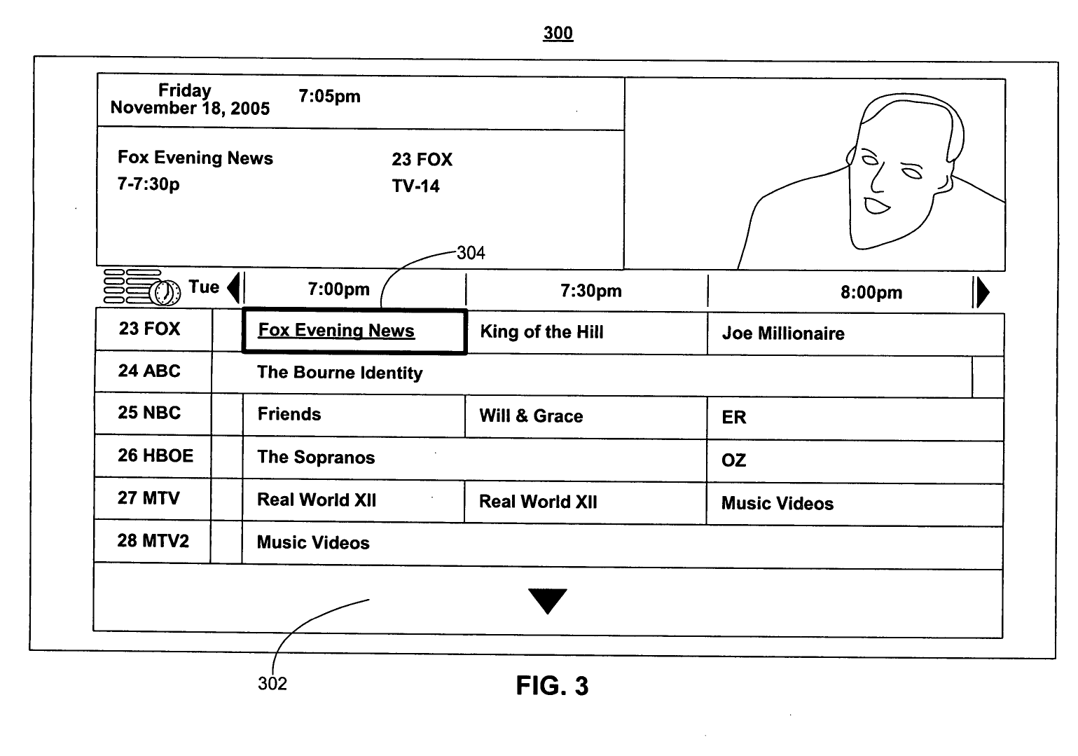

FIG. 3 shows one way to access a media program by using an interactive program guide application (IPG). The program guide 300 can be an application residing on user equipment or can be an online/networked program guide. As previously described herein, remote access of interactive media guidance applications is described in greater detail in U.S. patent application Ser. No. 11/246,392. Additionally, examples of interactive program guides showing a program listings region, a program description region, and/or a picture-in-guide region are described in U.S. Pat. Nos. 6,239,794, 6,563,515, and 6,564,378, which are incorporated herein by reference in their entirety. As shown in FIG. 3, the illustrated program guide 300 includes a program listings region 302 that can display a schedule of media programs. A user of the IPG can navigate a cell highlight 304 or a cursor, for example, to a particular program listing in the program listings region 302. By using an input device, such as a remote control, a user can select the highlighted program listing 304 for viewing, for recording, or for another form of access. In accordance with one aspect of the invention, the disclosed technology can present a user with media program versions or options through the interactive program guide 300, which will be described in more detail in connection with at least FIGS. 5-8E.

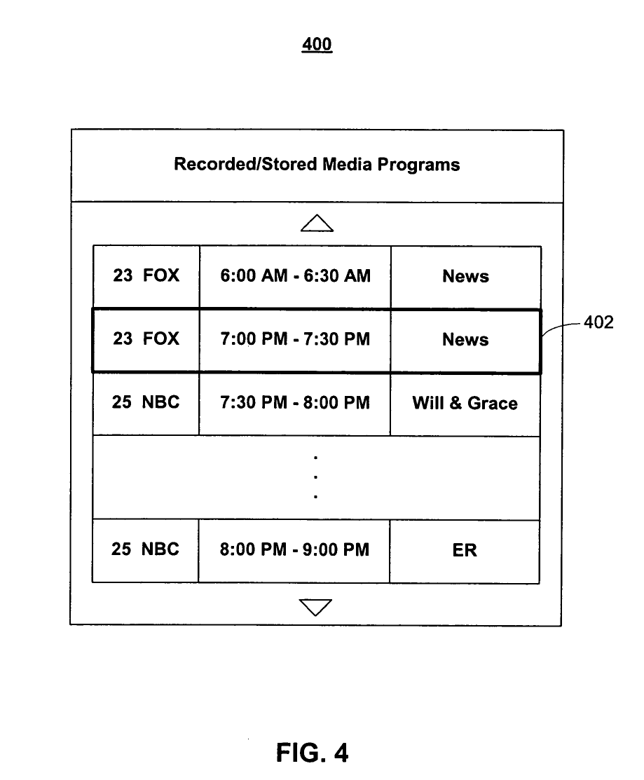

FIG. 4 shows one way of accessing a media program through a listing of recorded/stored media programs 400. The user equipment (not shown) can be general user equipment having a storage medium and a display screen that allows a user to interface with the storage medium. For example, the user equipment can be a digital video recorder (“DVR”), computer equipment, DVD player, cellular telephone, iPod or other mobile media player, pocket PC, or PDA. The user equipment can provide the illustrated display interface 400 to a user. The user can navigate a cell highlight 402 or a cursor, for example, to a recorded/stored media program. By using an input device, a user can select the highlighted program 402 for viewing or for another form of access. In accordance with one aspect of the invention, the disclosed technology can present a user with media program versions or options from a listing of recorded/stored media programs, which will be described in more detail in connection with at least FIGS. 5-7.

FIGS. 2-4 are illustrative do not limit the scope of the invention. It is contemplated that a user can access or record media programs using user equipment and platforms that are not shown or described herein.

In accordance with one aspect of the invention, when a user selects a media program for which alternative versions are available, the user equipment may present options allowing the user to select one or more of the alternative versions for access or recording. FIGS. 5-8 and the following detailed description describe exemplary display screens for presenting media program options to a user in connection with viewing or recording a media program.

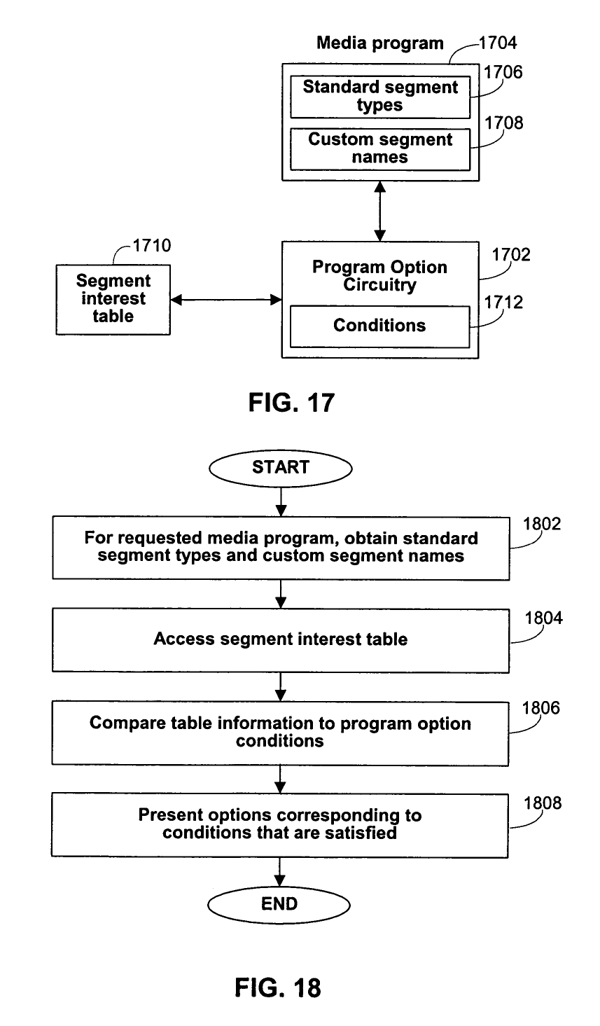

Referring now to FIG. 5, there is shown a display screen 500 that provides a user with an option to access a regular version of a media program or an extended version of the media program. The display screen 500 can be shown after a user changes a channel or after a user selects a program listing or stored media program, for example, as described above herein in connection with FIGS. 2-4. In the illustrated screen 500, there is an option to access an extended version of the media program 502. As used herein, an “extended version” refers to a media program that is related to and that has a longer duration than the regular version of the media program. For example, if the media program is the evening news, an extended version can be a longer version of the evening news that includes extra news footage. Additionally, in accordance with one aspect of the invention, the display screen 500 of FIG. 5 may be presented to a user based on conditions associated with the extended version and based on user interest in the media program's segments. For example, a condition associated with the extended version 502 may require a user to consistently watch the complete evening news program over a particular number of days, such that the display screen 500 is shown to the user only after the condition is satisfied. In this manner, the condition can operate to identify users who are more likely to be interested in the extended version. Media program conditions will be described in more detail in connection with FIGS. 17-19.

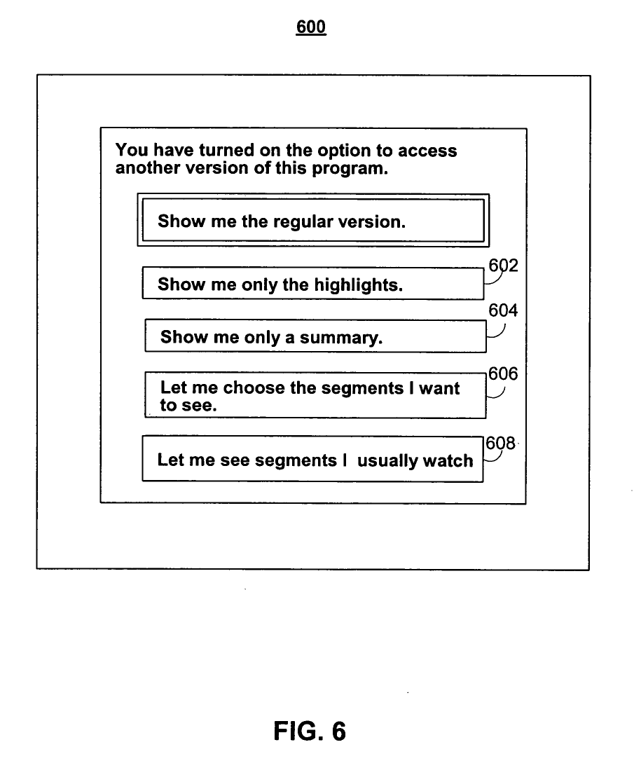

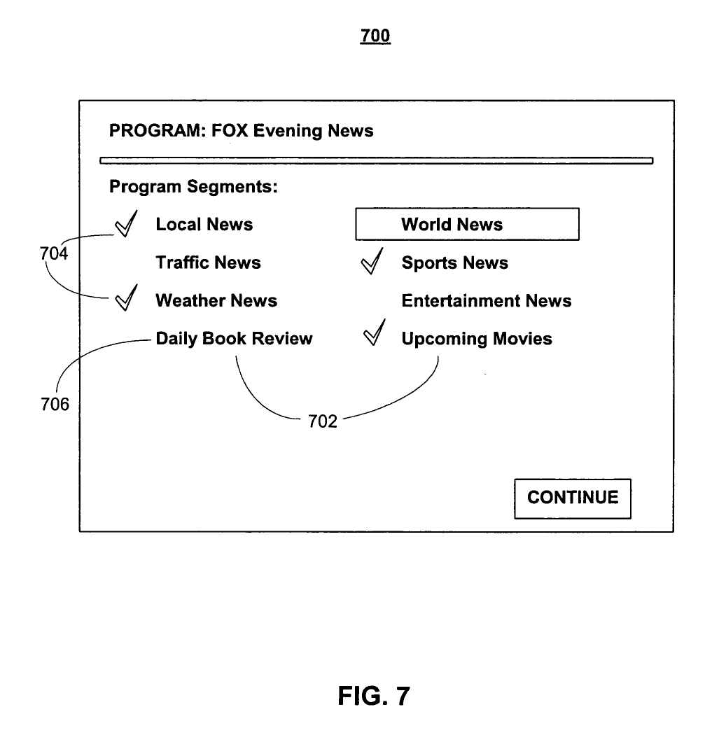

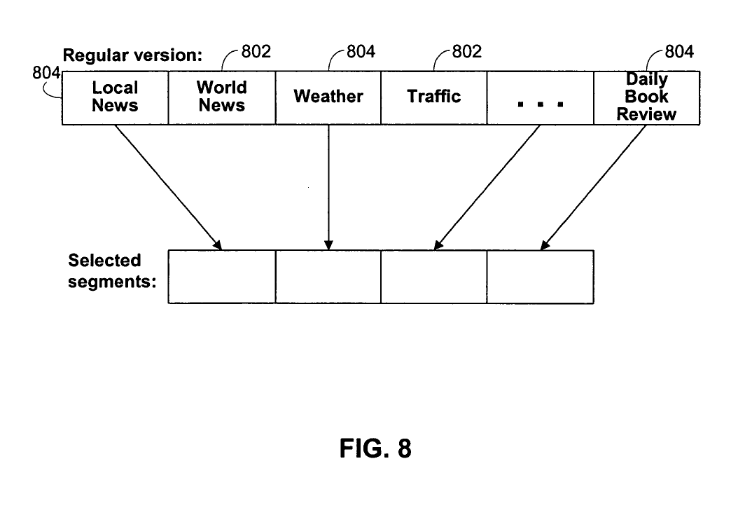

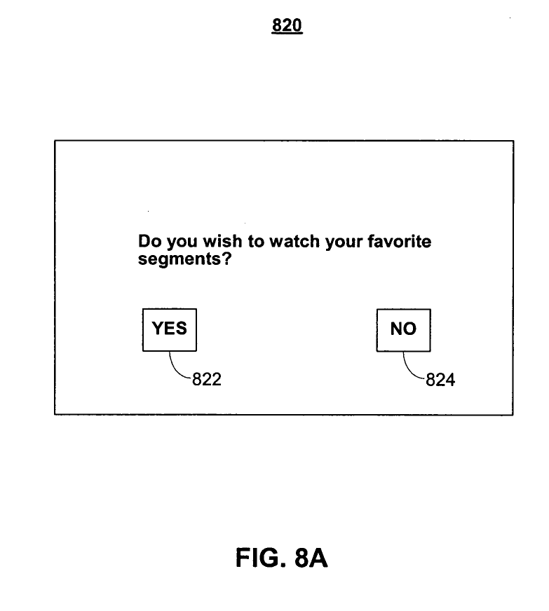

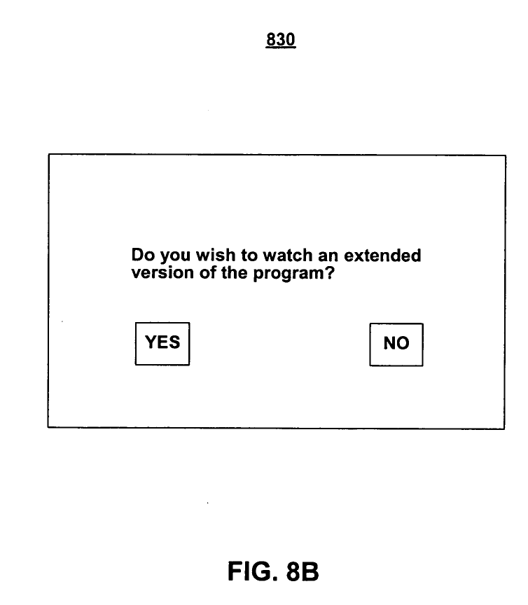

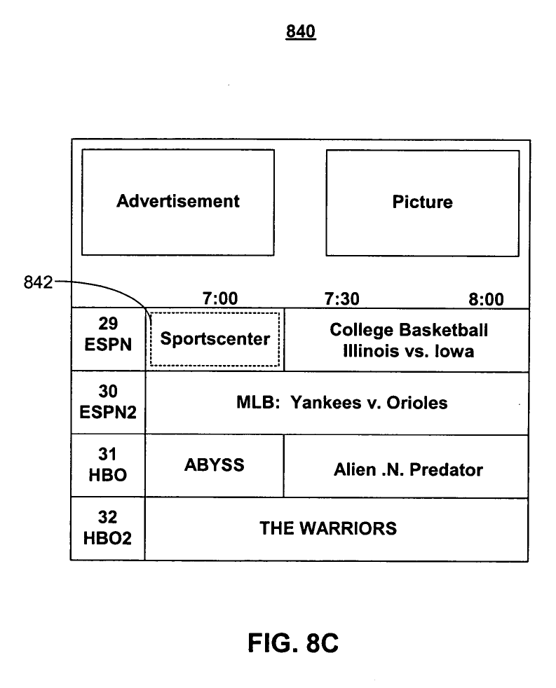

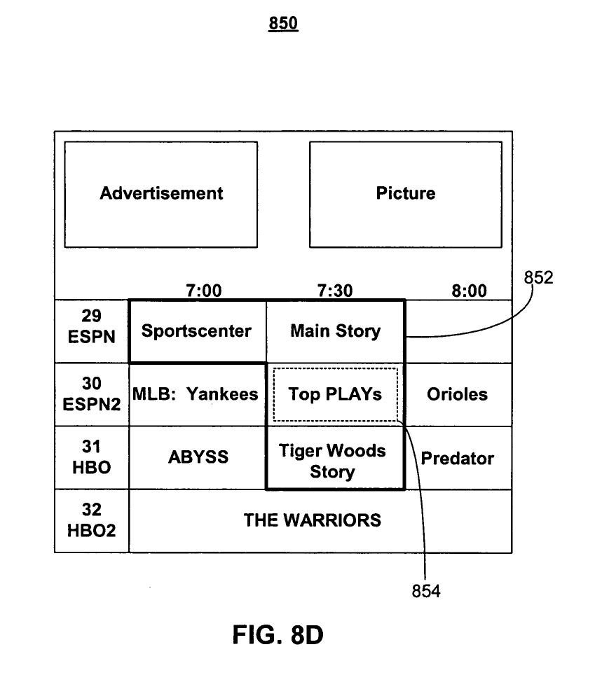

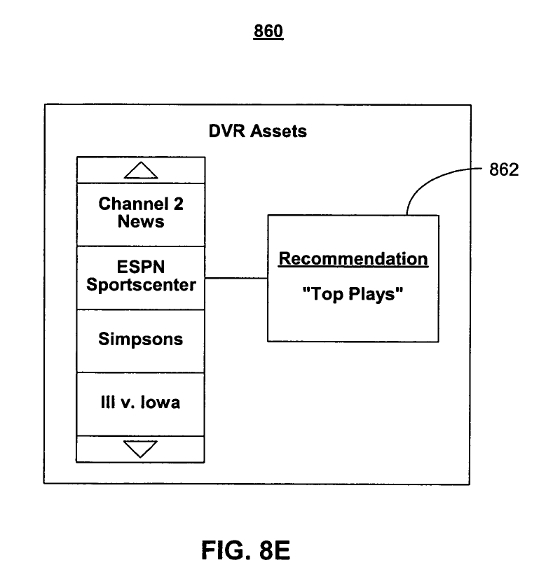

FIG. 6 shows another display screen 600 that provides a user with options to access yet other versions of a media program. In the illustrated screen 600, there are options to select a condensed version of a media program, such as a highlight version 602 or a summary version 604. In one embodiment, a highlight version of a media program 602 can be a compilation of important clips from various segments of the regular version. In one embodiment, a summary version of a media program 604 can be a scrolling or navigable text summary of the content or storyline of the media program. In one embodiment, the display screen can include an option for the user to designate particular segments of the regular version to access and particular segments to not access 606. This option 606 allows a user to generate a tailored version of a media program by designating segments of interest and will be described in connection with FIGS. 7-8. In one embodiment, the display screen can include an option for the user to watch the segments that the user usually watches 608. If option 608 is selected, the disclosed technology may, for example, present only the segments the user typically views for any given program (e.g., Late Show with David Letterman) or category of programming (e.g., news). A more detailed example of presenting the segments a user usually watches is described in connection with FIG. 8A. As described above, the options to access different versions 602-608 of a media program can be presented to a user based on conditions associated with the different versions and based on the user's interest in particular media program segments. In this manner, the media program conditions can operate to identify users who are more likely to be interested in the different versions 602-608. Media program conditions will be described in more detail in connection with FIGS. 17-19.

Referring now to FIG. 7, there is shown an exemplary display screen 700 that allows a user to generate a tailored version of a media program by designating particular segments of a media program to access/record and particular segments to not access/record. In one embodiment, the illustrated display screen 700 can be shown after a user selects the corresponding option 606 (FIG. 6) from the display screen 600 of FIG. 6. In one embodiment, the display screen 700 can show the labels of the segments 702 in the regular version of the media program. In one embodiment, the labels can be implemented as metadata in the media program. In one example, if the media program is the FOX evening news program, the news program may include segments such as local news, world news, traffic news, weather news, sports news, entertainment news, daily book review, and upcoming movies news segments 702, which can be identified by metadata in the media program. The user equipment can allow a user to designate particular segments to access by, for example, placing a check mark 704 next to the particular segment labels, and particular segments to not access by, for example, removing any check mark beside such segment labels 706. In this manner, a user can indicate which media program segments he or she is interested in accessing/recording 704, and which media program segments he or she is not interested in accessing/recording 706. For example, although a user may watch the FOX evening news, the user may have no interest in watching the world news, traffic news, entertainment news, and upcoming movie segments 706 of the evening news. Accordingly, as shown in FIG. 8, the unchecked segments 802 would not be presented to the user. Only segments that the user has designated with a check mark 704 can be presented/recorded. In one embodiment, the display screen 700 of FIG. 7 can initially be displayed with certain segment labels already checked, based on knowing a user's interest in the news program's segments or in analogous segments of other news programs.

In one embodiment, with continuing reference to FIG. 8, the regular version of a media program may be located at a user equipment or at a server/distribution facility. If the regular version is located at user equipment, the user equipment can perform the segment selection operation locally. In one embodiment, if the regular version is located at a server/distribution facility, the server/distribution facility can communicate the regular version to the user equipment and allow the user equipment to perform the segment selection operation locally. In another embodiment, the server/distribution facility can perform the segment selection operation and communicate the selected segments to the user equipment as a media file or as streaming media. In one embodiment, for a broadcast platform (e.g., cable, satellite), the selected segments can be communicated to the user equipment in an out-of-band analog or digital channel or in another channel that is different from the channel broadcasting the regular version. The user equipment can present the segment selections 804 or record the segment selections 804 as they are received. One skilled in the art will recognize that existing analog and/or digital communications technologies can be used to communicate the regular version of the media program or the segment selections 804 to user equipment.

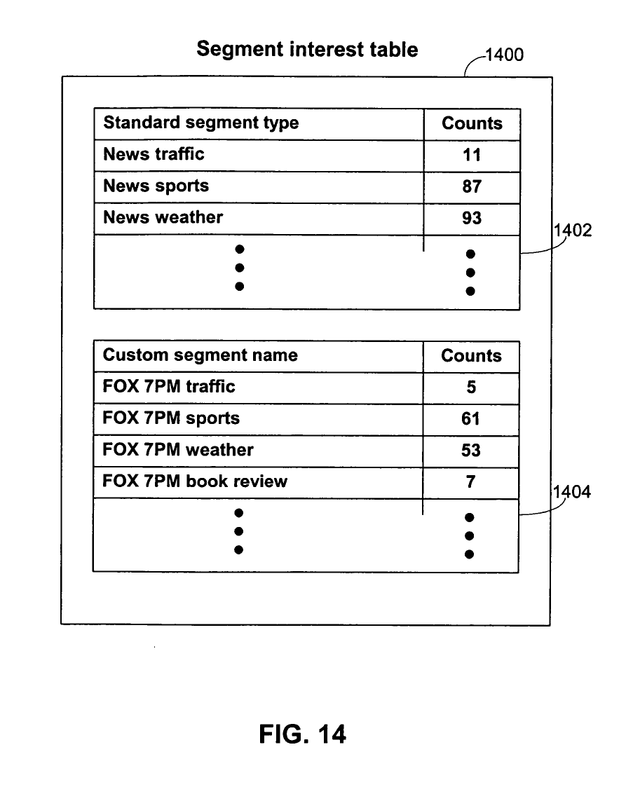

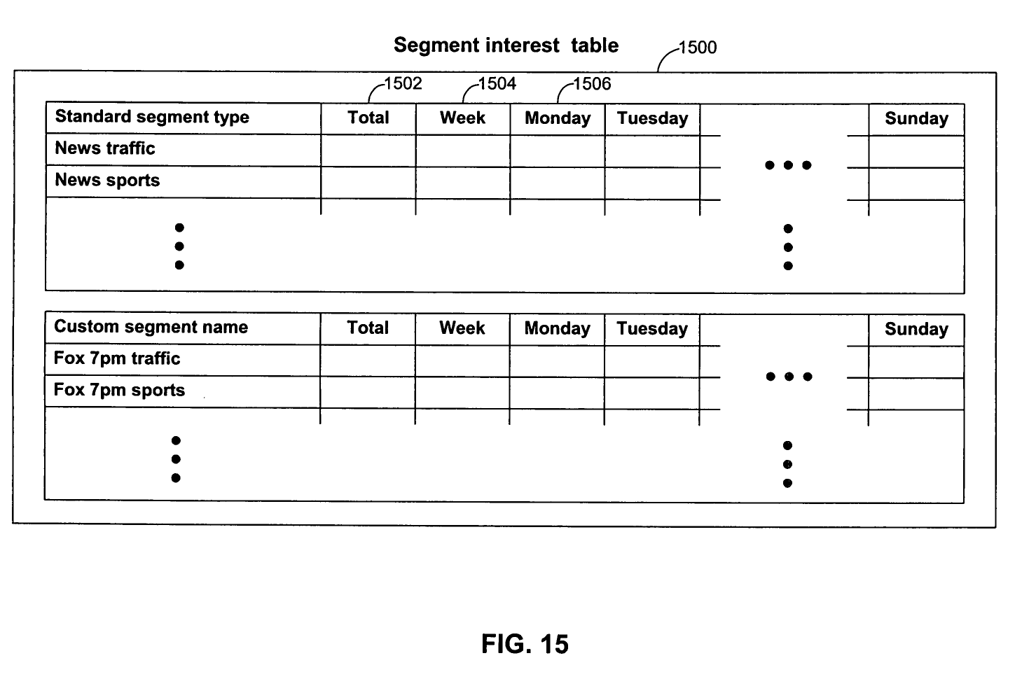

In one embodiment and with continuing reference to FIG. 8, the regular version of a media program may be playing on a broadcast platform. A recording device (not shown) may know the user's designations from FIG. 7 or may know the user's interest in the media program's segments. Accordingly, the recording device can, in one embodiment, tune in to the media program and record only the segments which the user has designated for recording or which the user's interest information indicates would be of interest to the user. Segment interest information is described in more detail in connection with at least FIGS. 14-15.

FIG. 8A is a screen shot that may be displayed prompting a user to select whether the user wishes to watch his or her favorite segments for the program the user is accessing. Prompt screen 820 may be displayed, for example, when a user changes the channel, accesses a video-on-demand program, accesses a program stored on a digital video recorder, or in response to any other suitable action. If the user chooses NO option 824, the program guide may display the regular version of the program. If the user chooses YES option 822, the program guide may display an alternative version of the program. Many different alternative versions of the program may be displayed, depending on, for example, the program being accessed or user monitored viewing activities of the program or category of programming being assessed, or both.

In one embodiment, the interactive program guide may provide an option to view a condensed alternative version of programming. For example, assume that a user likes watching sports and typically watches the “Top Plays” or “sTop Sports Highlights” segment of a particular sports program (e.g., ESPN Sportscenter). The interactive program guide may keep track of the user's preferred interest in watching the “Top Plays” segment of sports programming. Thus, when the user accesses that particular sports program (e.g., ESPN Sportscenter), the program guide may prompt the user to select whether he wishes to watch the “Top Plays” segment of that program. As an alternative to the foregoing, when the user accesses a similar but different sports program (e.g., FOX Sports), the program guide may prompt the user to select whether he wishes to watch the “Top Plays” segment of that program. Note that the program guide may prompt the user to watch the “Top Plays” segment of the different program even if the user has not viewed the different program or if the program guide has not tracked which segments of that different program the user has watched.

The foregoing embodiment may be further explained by the following example. Assume that the program guide has monitored that the user typically likes to watch only the local news and weather segments of the news. When the user accesses a news program, regardless of whether it is a news program the user typically watches (e.g., channel 7 news) or a news program the user normally does not watch (e.g., channel 2 news), the program guide may prompt the user whether he wishes to watch his favorite segments.

In another embodiment, the program guide may provide an options screen such as options screen 830 of FIG. 8B for a user to select an extended alternative version of programming. For example, assume that the program guide has determined that the user may be interested in watching “extra” media associated with programming, if available. The “extra” media may include, for example, the director's cut, director commentary, interviews with actors, theatrical trailers, behind-the-scenes, or other media that is typically not displayed as part of the regular program. When the user accesses programming that may have an alternative extended version, the program guide may prompt the user to select whether the user wishes to view the alternative extended version.

The program guide may provide the user with a segment selection menu of available segments that a user may select and watch when the user accesses a program, for example, through a program guide screen (e.g., FIG. 3). Such a feature is discussed in connection with FIGS. 8C and 8D. FIG. 8C shows a display screen 840 of programming (e.g., broadcast programming, VOD programming) that may be available for viewing. A user may navigate a highlight region 842 to various program listings displayed on display screen 840. When the user selects a program, the program guide may provide a user with a segment selection menu including available segments that may be selected for viewing. FIG. 8D shows an example of a segment selection menu 852 (outline in bold) that may be presented in accordance with an embodiment of the invention. The segment selection menu may be displayed when the user presses a predetermined key on an input device or the program guide may provide the user with an option to have the segment selection menu displayed when a program listing is selected.

Segment selection menu 852 may be displayed in response to a user selection of the Sportscenter program listing in FIG. 8C. For example, segment selection menu 852 may expand out of the Sportcenter listing to show that the segments pertain to Sportscenter. The user may navigate a highlight region 854 to select one or more of the segments for viewing. For example, if the user selects the “Top Plays” segment, the program guide may play the “Top Plays” segment of Sportscenter. As described above herein, the selected segment can be communicated to the user equipment in a number of different ways or may already be stored on the user equipment.

In one embodiment, the program guide may recommend segments for the user to watch when the user accesses a particular program. FIG. 8E shows display screen 860, which may be a listing of programming recorded on a digital-video-player. When the user selects a listing such as the “ESPN Sportscenter” program listing, the program guide may display a segment recommendations window 862, which may be an expansion of the selected program listing. Segment recommendations window 862 may include one or more segments the program guide recommends for the user. For example, a user may typically watch the Top Plays segment of ESPN Sportscenter but the user may not know about an analogous Top Plays segment in Fox Sports. In one embodiment, the Top Plays segment of Fox Sports can be presented to the user even when the user may not have accessed Fox Sports. In this embodiment, based on knowing that a user typically watches the Top Plays segment of ESPN Sportscenter, the disclosed technology can seek out other media programs that have a Top Plays segment analogous to the Top Plays segment in ESPN Sportscenter and can find the Fox Sports media program in that manner. If desired, the user may then select one or more of the recommended segments for viewing. The segment recommendation menu 862 may be displayed when the user presses a predetermined key on an input device, or the program guide may provide the user with an option to have the segment recommendation menu displayed when a program listing is selected.

In one aspect of the invention, a user equipment can determine the availability of different versions of a media program in different ways. For example, in the scenario of FIG. 2, where the user equipment may receive a broadcast media program, the media program signal can include metadata to indicate the availability and/or location of other versions of the media program. If the media program signal is an analog signal, the metadata can be encoded in the vertical blanking interval of the analog signal or in another suitable interval. If the media program signal is a digital signal, the metadata can be interleaved among the media program content. Therefore, the exemplary display screens of FIGS. 5-6 can appear after the metadata is received and processed. In the scenario of FIG. 3, where the user equipment is using a media guidance application, the media guidance application can have information about the availability and/or location of other versions of a media program. Therefore, in one embodiment, the exemplary display screens of FIGS. 5-6 can appear when the user has selected a program listing for access or recording, but before the user equipment tunes to or receives the selected media program. Alternatively, the display screens of FIGS. 5-6 can appear after the user equipment tunes to or receives the selected media program. The display screens can appear when the media guidance application is still open, or after the media guidance application has been closed and the media program is displayed in full screen. In the scenario of FIG. 4, where the user is accessing a list of recorded/stored media programs, the recorded/stored media programs can include metadata or header information to indicate that other versions of the media program are available. If the stored media programs have header information, the header information can include the types and locations of the different media program versions. If the stored media programs do not have header information, the media programs can include metadata, as described above in connection with the scenario of FIG. 2. The user equipment can access the indication either in the header information or in metadata embedded in the media program. The exemplary display screens of FIGS. 5-6 can be displayed while the media programs list is open, or after the media programs list has been closed and the selected media program is displayed in full screen.

In accordance with one aspect of the invention, a user can be presented with media program options based on the user's interest in particular media program segments. The media program options can include, for example, an opportunity to access/record different versions of a media program. FIGS. 9-16 and the following detailed description will now describe this aspect of the invention.

FIG. 9 shows an exemplary data structure 900 that can be used to identify a media program segment. The data structure 900 can be implemented as metadata and can be embedded in a media program. For example, the data structure 900 can be encoded in a vertical blanking interval of an analog signal or in another suitable interval, or the data structure 900 can be interleaved among the content of a digital signal. In a platform in which a user can switch among multiple channels or otherwise switch among multiple media programs, the data structure 900 can occur in the media programs periodically so that the user equipment will be able to identify media program segments even when a user tunes-in mid-way into a media program segment.

In the illustrated embodiment, the data structure 900 includes a field that identifies the data structure as containing media program segment information 902. The field 902 need not contain the string “Segment Information” and can contain another value. The data structure also includes a field that characterizes a media program segment as one or more standardized segment types 904. The standard segment types can be defined by an industry group, for example. In contrast, the illustrated data structure also includes a field for identifying a media program segment using one or more custom segment names 906. The custom segment names 906 may or may not be standardized. In one embodiment, the custom segment name(s) 906 can include names used by a programming station and/or a program producer, for example. In one embodiment, segment information may specify both standard segment type(s) 904 and custom segment name(s) 906. In other embodiments, segment information may specify only standard segment type(s) 904 or only custom segment name(s) 906 both not both. In one embodiment, different media programs that have analogous or relevant program segments can use the same standard segment types 904 or the same custom segment names 906. For example, “Top Plays” may be a standard segment type or a custom segment name. The Top Plays segment of ESPN Sportscenter and the analogous Top Plays segment of FOX Sports can each include the illustrated data structure 900 and can include the “Top Plays” standard segment type/custom segment name. In this manner, if a user typically watches the Top Plays segment of ESPN Sportscenter, the disclosed technology can determine, based on the “Top Plays” standard segment type/custom segment name in the FOX Sports media program, that the user may also be interested in watching the Top Plays segment of FOX Sports.

The illustrated data structure 900 also includes a field that specifies a minimum tune-in duration Tint 908 that is required for the user to establish interest in the media program segment. In one example, if a media program segment is five minutes long, the minimum tune-in duration required to establish interest in the segment may be four minutes. However, if the media program segment is three minutes long, the minimum tune-in duration required to establish interest in the segment may be two minutes. The value of the minimum tune-in duration 908 can be defined by a programming station or a program producer, for example, and can vary depending on the content and length of the segment.

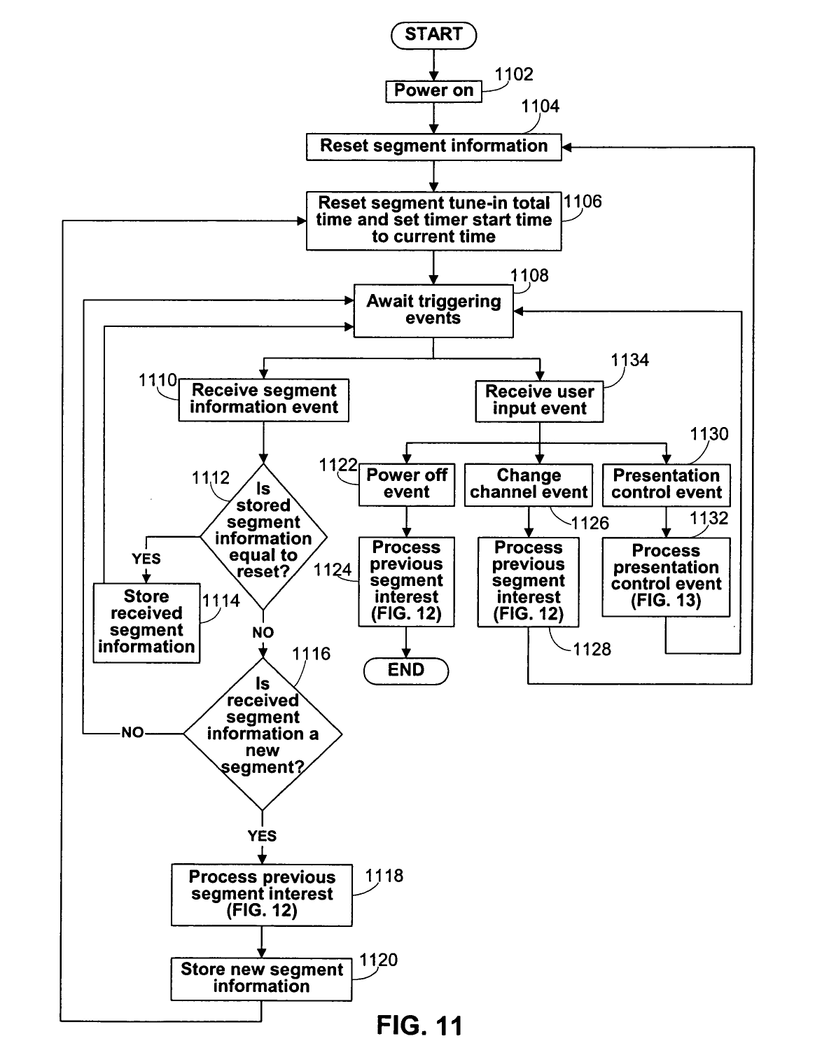

In accordance with the data structure 900 of FIG. 9, user interest in a media program segment can be established based on a minimum tune-in duration Tint 908. FIG. 10 shows a block diagram of an exemplary segment tune-in timer circuit 1000 for computing tune-in time and for determining whether the total tune-in time for a segment is greater than the Tint for the segment. In the illustrated embodiment, the timer circuit 1000 includes a memory for recording the start time of the timer 1002, a memory for recording the total tune-in time for a segment 1004, and a memory for recording received segment information 1006. The timer circuit can receive a current time from a clock circuit 1008 and can receive segment information 1010 from a media program signal. The segment tune-in timer circuit 1000 can also detect user commands 1012 that may affect the timing computation. For example, if a user pauses, fast-forwards, rewinds, or stops a media program, or powers off the user device, the timer circuit can stop the timer because those commands can indicate that a user is no longer watching the media program segment that was being tracking. On the other hand, a play command can cause the timer circuit to begin the timer, and, similarly, a channel or program switch command can cause the timer circuit to end the timer for a segment and begin the timer for a new segment. In one embodiment, when it is clear that a media program segment has ended or stopped, or when a user switches to another channel or program, the timer circuit 1000 can compare the total segment tune-in time 1004 for the segment with the Tᵢₙₜ value in the stored segment information 1006. If the segment tune-in time 1004 is longer than Tᵢₙₜ (908, FIG. 9), the timer circuit 1000 can access a segment interest table 1014 to indicate that there was sufficient interest in the media program segment. These operations are described in detail in FIGS. 11-13. FIGS. 14-16 show examples of segment interest tables. The following illustrations and corresponding detailed description are exemplary do not limit the implementation or operation of the segment tune-in time circuitry.

Referring now to FIG. 11, there is shown a flow diagram of the operation of the segment tune-in timer circuit of FIG. 10. The illustrated embodiment operates to keep track of the time during which a user equipment presents a particular media program segment. When the user device is first powered on 1102, the timer circuit resets its segment information memory 1104, resets its segment total tune-in memory, and sets its timer start time memory to the current time 1106. The timer circuit then waits for events that trigger a change in one or more of its memories or that trigger a computation 1108.

One triggering event is the receipt of segment information (e.g., data structure of FIG. 9) which identifies the segment that is being presented 1110. If the received segment information is the first segment information to be received (i.e., the segment information memory is empty) 1112, the timer circuit stores the received segment information in the segment information memory 1114 and again waits for a triggering event 1108. However, if the received segment information is not the first segment information to be received 1112, the timer circuit can determine if the received segment information indicates that the media program has entered a new segment (i.e., if the received segment information is different from the stored segment information) 1116. If the media program is still in the same segment, the timer circuit can return to waiting for triggering events 1108. On the other hand, if the media program has entered a new segment, the timer circuit can process the user interest in the segment that ended 1118, and then store the received segment information in the segment information memory 1120 and again wait for triggering events 1108.

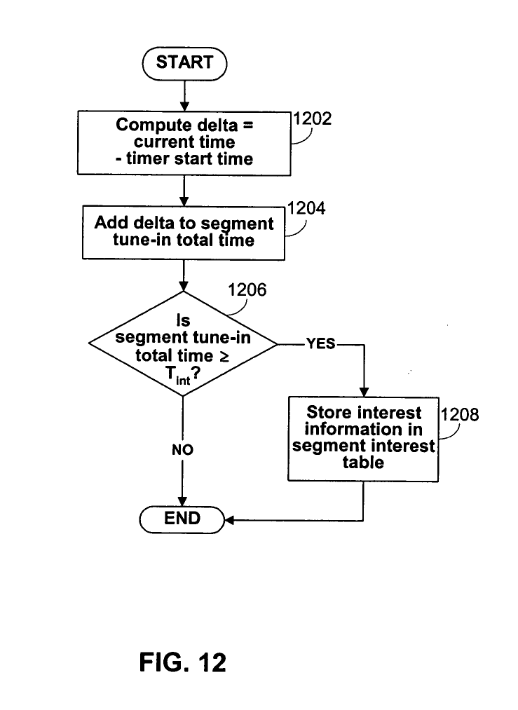

The flow chart of FIG. 12 shows one embodiment of processing user interest in a segment. Referring to FIG. 12, the timer circuit can compute the difference between the timer start time and the current time to compute the timed tune-in duration, which will be referred to herein as “delta” 1202. The timer circuit can then add delta to the segment tune-in total time 1204. If the segment tune-in total time is greater than or equal to Tᵢₙₜ 1206, the timer circuit records the user interest information in the segment interest table (e.g., FIGS. 14-16) 1208. In the illustrated embodiment, if the segment tune-in total time is less than Tᵢₙₜ 1206, the processing is complete and nothing is stored in the segment interest table.

FIG. 14 shows one embodiment of a segment interest table in accordance with one aspect of the invention. In one embodiment, the table 1400 can be stored at the user equipment. In one embodiment, the table 1400 can be stored at a location remote from the user equipment. In the illustrated embodiment, the table 1400 can maintain a list of user interest for standard segment types 1402 and a list of user interest for custom segment names 1404. In other embodiments, the table can maintain only one list containing both standard segments types 1402 and custom segment names 1404, or the table can maintain more than two lists by sub-dividing the standard segment types 1402 or the custom segment names 1404. When the timer circuit updates the segment interest table 1400, the timer circuit can add one count in the table for each standard segment type 1402 and each custom segment name 1404 indicated in the segment information (1006, FIG. 10) stored in the timer circuit. For example, if the user equipment is updating the segment interest table 1400 for the traffic segment of the FOX 7 PM evening news program, the traffic segment may have a standard segment type of “News traffic” and a custom segment name of “FOX 7 PM traffic.” If user interest is established for this segment, the timer circuit can add a count to both of these entries in the segment interest table 1400. In general, it is intuitive that the standard segment type entries 1402 in the table may have greater counts than those for the custom segment names 1404 because the standard segment types 1404 may be used more frequently for different media programs (e.g., all news programs throughout the day), while the custom segment names 1404 may be used only for particular media programs (e.g., FOX 7 PM evening news).

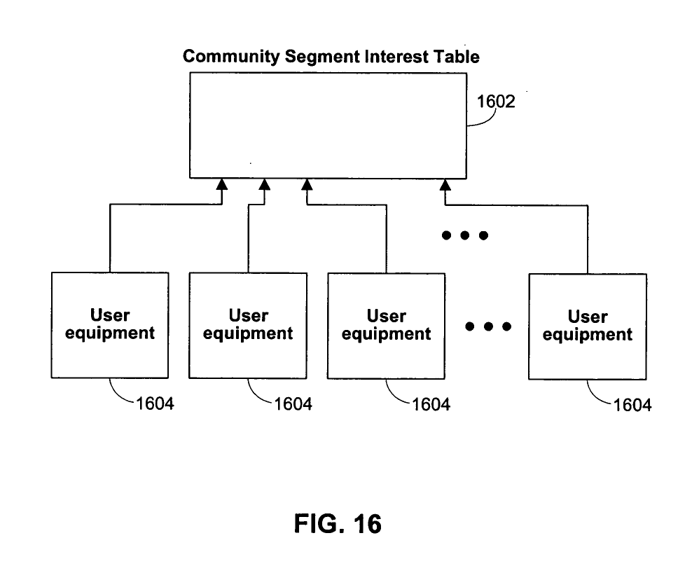

FIG. 15 shows a variation of the segment interest table of FIG. 14. The table 1500 of FIG. 15 contains multiple interest counts 1502-1506 for each standard segment type and each custom segment name. The table 1500 can maintain a longer-term count, such as a total count 1502, as well as shorter-term counts, such as a weekly count 1504 or a daily count 1506. FIG. 16 shows a configuration in which a community segment interest table 1602 is maintained based on user interest information from multiple user equipment 1604. In one embodiment, the community segment interest table 1602 can be located remotely from the user equipment 1604, such as on a remote server or at a distribution facility. In one embodiment, the community segment interest table 1602 can be located on a home server, and the user equipment 1604 can belong to household members using the home server. In one embodiment, the community segment interest table 1602 can be accessed and used by user equipment that is not part of the community's user equipment 1604.

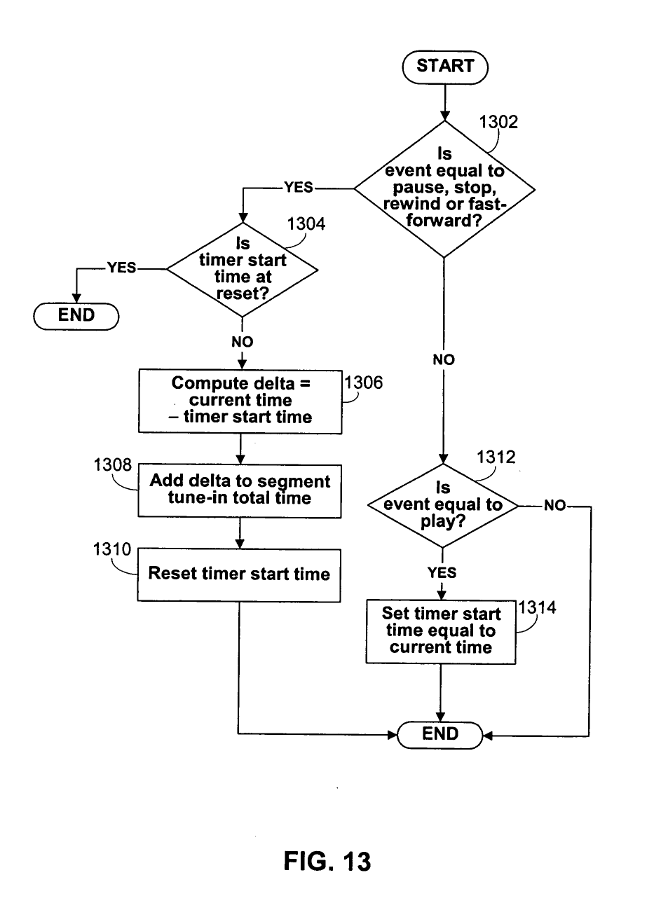

Returning to FIG. 11, other trigger events that may effect the timer operation include user commands received from a user interface device 1134. If the command is a power off command 1122, the timer circuit can process user interest in the tracked segment 1124 before turning off the user equipment. If the command is a change channel or change program command 1126, the timer circuit can process user interest in the tracked segment 1128 before, during, or after changing to the different channel or program. After the timer circuit processes user interest in the tracked segment 1128, the timer circuit can reset its memory contents 1104, set the timer start time to the current time 1106, and wait for triggering events 1108. If the triggering event is a presentation control event (e.g., pause, rewind, play) 1130, the timer circuit can process the presentation control event 1132 in accordance with FIG. 13. A presentation control event 1130 can occur if a user is controlling the presentation of a stored media program, for example. In the embodiment of FIG. 13, the timer circuit considers a play command as the only command that requires the timer to keep track of tune-in time. For other commands, the timer circuit halts the timer. For the user commands pause, stop, rewind, and fast-forward 1302, the timer circuit does nothing if the timing operation is already halted 1304. In one embodiment, the timer circuit can indicate the halt by setting the timer start time to a reset value. Therefore, if the timer start time is already at reset 1304 when a user issues a pause, stop, rewind, or fast-forward command, the timer circuit need not do anything. However, if the timer operation is running and is not at reset, the timer circuit can compute delta (i.e., current time minus timer start time) 1306, add delta to the segment tune-in total time 1308, and set the timer start time to the reset value 1310. If the user command is a play command 1312, the timer circuit can enable the timing operation by setting the timer start time to the current time 1314. For all other commands, the illustrated embodiment does nothing. It is contemplated that there may be other commands not described herein which may effect the timer operation. The timer circuit can handle those other commands in accordance with the principles described above herein.

FIG. 11 is illustrative and other triggering events that are not described herein can also be handled by the timer circuit in accordance with the principles described above herein. One skilled in the art will recognize that, in one embodiment, triggering events can be handled using hardware or software interrupts in a processor-based computing architecture.

In accordance with one aspect of the invention, user interest information can be used to determine which media program options, if any, should be provided to a user. FIG. 17 shows one embodiment of a program option circuit 1702 for determining which options, if any, should be provided to a user. The program option circuit 1702 can be located in user equipment and/or in a server/distribution facility. The program option circuit 1702 can be in communication with a media program 1704 that contains segment information having standard segment types 1706 and/or custom segment names 1708 (e.g., FIG. 9). The program option circuit 1702 can also be in communication with a segment interest table 1710 (e.g., FIGS. 14-16), which may be local to or remote from the program option circuit 1702 and which can be a community segment interest table (e.g., FIG. 16). In one embodiment, the program option circuit 1702 can include media program conditions 1712 that are associated with particular media program options (not shown) and that are tied to user interest information 1710. In various embodiments, the conditions 1712 can be located at the user equipment or at a server/distribution facility. The conditions 1712 may be embedded in or stored separately from a media program 1704. In one aspect of the invention, a condition 1712 associated with a particular media program option can determine whether or not the media program option is provided to a user. In this manner, the media program conditions 1712 can further the benefit of providing users with media programs versions that they will likely enjoy.

As an example, an extended version of a media program may be available. Assuming that only users who are very interested in the media program would want access the extended version, the conditions 1712 associated with the extended version can require a user to be equally interested and recently interested in each of the segments of the media program 1704. For example, referring to the segment interest table 1500 of FIG. 15, the condition may require that the total counts 1502 for each of the segments in the media program be substantially the same. The condition may also require that the week counts 1504 for each of the segments in the media program be substantially the same. In various embodiments, the program options circuit may determine “substantially the same” in different ways. In one embodiment, the highest and lowest counts may need to have less than a particular difference. In one embodiment, the counts may all need to be within a particular number or within a particular percentage of the mean. Referring again to FIG. 17, if the user interest information satisfies the condition 1712, the program option circuit 1702 can present the user with the associated media program option, which may be an option to access/record an alternative version of a media program (e.g., FIGS. 5-7). In this manner, the program option circuit 1702 can provide media program options to users who will likely be interested in them.

One embodiment of the operation of the program option circuit is shown in FIG. 18. When a user has selected a media program for access or recording, as described above herein, for example, in connection with FIGS. 2-4, the program option circuit can know or can identify the media program that was selected. The program option circuit can obtain the standard segment types and the custom segment names of the media program's segments by, for example, examining the media program to extract that information 1802. The program option circuit can access a segment interest table to locate entries corresponding to the standard segment types and custom segment names of the media program 1804, and can compare the interest counts of the located entries to the media program conditions 1806. The conditions can be based on standard segment types or custom segment names or both. For conditions which are satisfied, the media program options corresponding to those conditions can be presented to the user 1808.

In one embodiment, a media program option can include a highlight version of a media program. As described above herein, a highlight version of a media program can be a compilation of important clips from various segments of a media program. In one embodiment, a user may be interested in a highlight version if the user typically catches only some segments of the media program but not other segments. Accordingly, a condition associated with a highlight version can require that there be more user interest in some segments of the media program and less interest in the remaining portions of the media program. In one embodiment, more interest can refer to interest counts that are greater than the mean of the relevant counts and less interest can refer to interest counts that are less than the mean. In one embodiment, a condition can require that the proportion of more-interest segments to less-interest segments be no less than a particular proportion, such as one:two, for example.

In one embodiment, a media program option can include a summary version of a media program. As described above herein, a summary version of a media program can be a scrolling or navigable text summary of the content or storyline of the media program. In one embodiment, a user may only be interested in the summary version if the user barely watches the media program at all. Accordingly, a condition associated with a summary version can require that there be more user interest in some segments of the media program and less interest in the remaining portions of the media program, but also require that the proportion of more-interest segments to less-interest segments be no more than a particular proportion, such as one:four, for example.

In one embodiment, a media program option can include an option to have the user generate a tailored version of a media program by designating particular segments to access and particular segments to not access, as described above herein in connection with FIG. 7. In one embodiment, a user may be interested in this option if the user typically watches particular segments and but not other segments. Accordingly, a condition associated with this media program option can require that there be substantially more user interest in some segments of the media program than in the remaining portions of the media program.

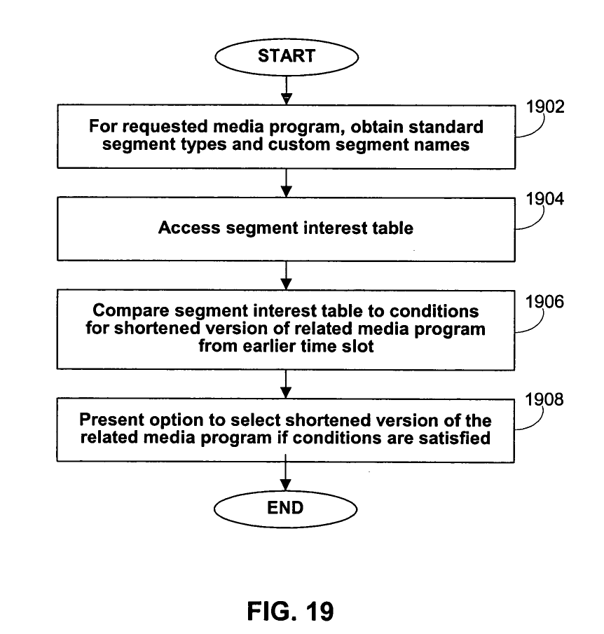

In one embodiment, and with reference to FIG. 19, when a user selects a media program for access or recording, the program option circuit may present an option to allow the user to access/record a condensed version of a related media program from an earlier time slot. For example, this option may be particularly applicable to episodes in a series. If a user consistently watches the series but misses a particular episode, the program option circuit can allow the user to access a summary version of the missed episode, for example. Accordingly, with reference also to FIG. 15, a condition for this option may require the long term counts (e.g., total counts 1502) for segments in the media program to be substantially the same, and may require the short term counts (e.g., the counts for the day of an episode 1506) to be substantially zero 1902-1906. For example, if a series airs every week on Monday and a user typically watches the entirety of each episode, the total counts for the segments in the media program can be substantially the same. However, if the user misses an episode, the Monday count would be zero. In this situation, the media program condition can allow the user to access an option to view/record a condensed (e.g., summary) version of the missed episode 1908. In one embodiment, the disclosed technology can recognize when a user has missed an episode of a series that he typically watches and can automatically record the episode that was missed. For example, the disclosed technology can access the segment labels for media programs that will soon be airing, and compare the labels to an segment interest table. If it is determined that a user typically watches a media program that is about to air and the user equipment is not tuned to the program or is powered off, the media program or one of its alternative versions can be recorded and presented to a user at a later time.

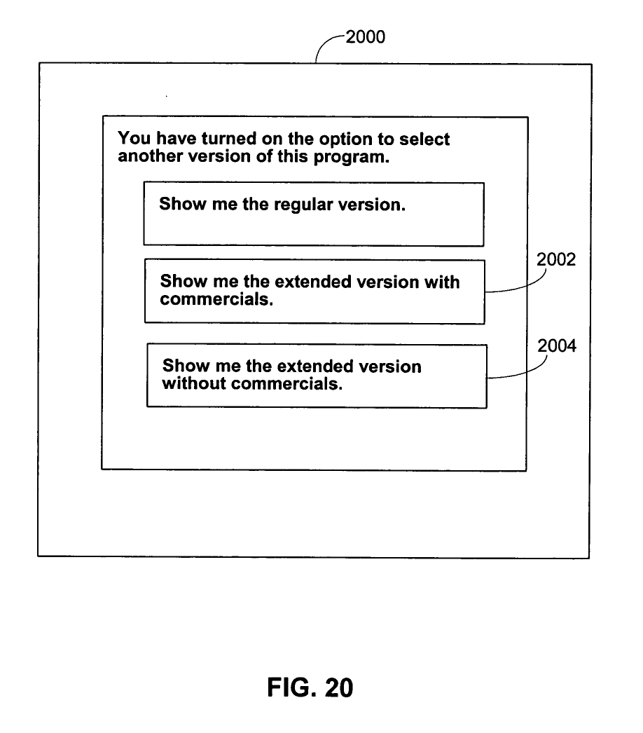

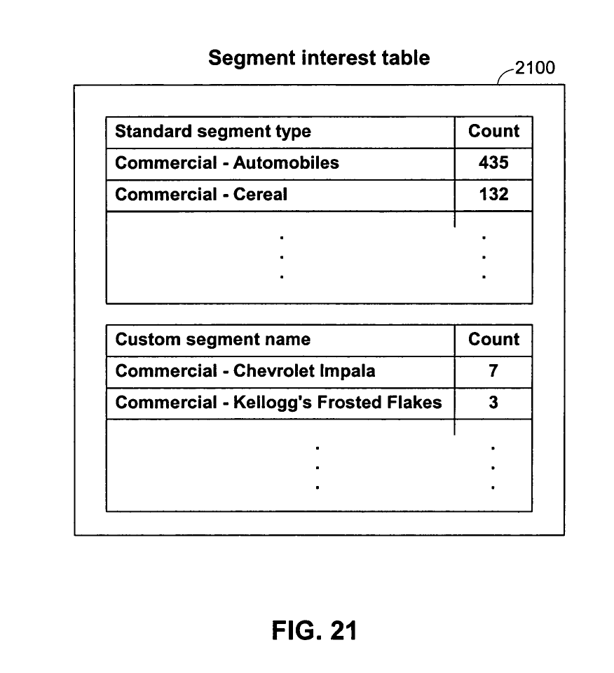

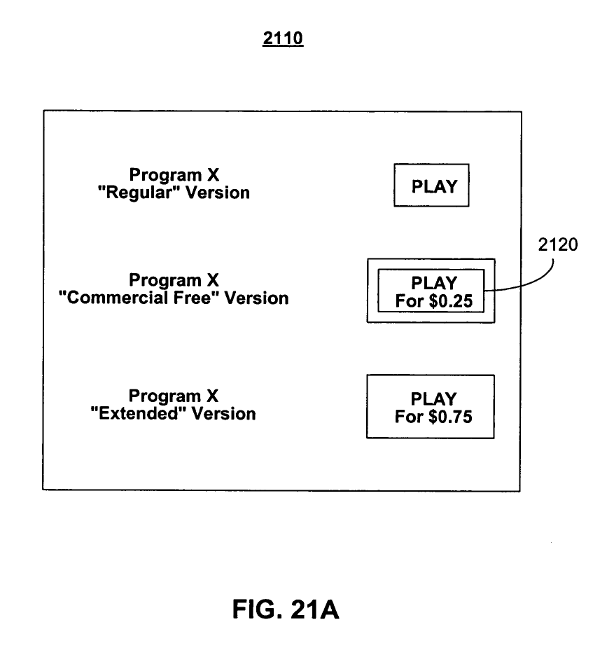

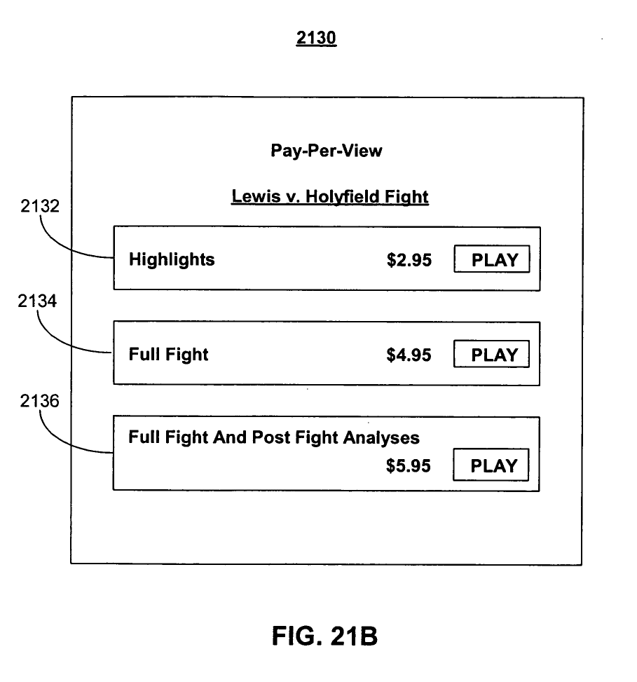

In accordance with one aspect of the invention, media program options can include alternative versions with commercials 2002 and alternative versions without commercials 2004, as shown in the exemplary display screen 2000 of FIG. 20. In one embodiment, the conditions associated with an option to access a media program version with commercials and an option to access a media program version without commercials can be the same. In one embodiment, the condition associated with an option to access a media program version without commercials can be based on a user's interest in commercial segments, one example of which is shown in FIG. 21. In one embodiment, the option to access a media program version without commercials may require an additional charge.

Referring to FIG. 21, a segment interest table 2100 can include user interest in commercial segments. In one embodiment, a commercial can include only one segment. In one embodiment, the minimum time duration to establish a user's interest in a commercial can be the entire duration of the commercial. The segment tune-in timer circuit of FIGS. 10-13 can process user interest for commercials in the same way it processes user interest for other media programs. In one embodiment, a condition for an option to access a media program version without commercials can require the commercial segment entries in the segment interest table to be relatively few and the counts for those entries to be relatively low. In one embodiment, a condition for an option to access a media program version with commercials can require the commercial segment entries in the segment interest table to be relatively many and the counts for those entries to be relatively high. In one embodiment, a media program version with commercials can include commercials that are selected based on the commercial segment entries in a segment interest table 2100. For example, the commercials presented to a user can be selected to correspond to the commercial entries in the segment interest table 2100 that have higher counts. In one is embodiment, the disclosed technology can use a user's interest in segments of commercials to determine which commercials to record and which commercial to not record. For example, if a user typically watches BMW car commercials but does not watch Mercedes car commercials, the disclosed technology can record BMW commercials but not record Mercedes commercials. In one embodiment, the disclosed technology can use a user's interest in segments of commercials to select commercials to present to a user. Continuing with the car commercial example, the disclosed technology can select more BMW car commercials to present to the use based on knowing that the user watches BMW commercials.

In one aspect of the invention, embodiments of the present invention may be used across platforms. That is, user activities (e.g., viewing habits) may be monitored for different types of platforms and content may be tailored to each different type of platform based on monitored activities. For example, a user may have a platform that is typically used in the user's home (e.g., set-top-box) and a platform that the user may carry on his person (e.g., a wireless personal device). In this example, the two platforms are referred to as the set-top-box and the personal device. If the user typically watches sports and news programming on the personal device, the media application may provide sports and news segments that may be viewed. If the user watches movies and news with the set-top-box, the media application may tailor display screens to offer segments related to movies and news. In one embodiment, if the interactive program guide is a networked program guide and is in communication with different types of user devices, the interactive program guide can access the separate segment interest information for the different devices. Therefore, the interactive program guide may know that viewing habits on different devices may be different and may provide different media program versions or options to different devices.

FIG. 21A shows a display screen 2110 that illustrate different business models of programming that may be provided for a user in accordance with an embodiment of the present invention. That is, the media application may provide a user with an opportunity to view regular and alternative versions of programming at different prices, or for no price at all. Display screen 2110 may be displayed, for example, when the user selects a program listing (shown here as Program X). The user may be provided with the option to view the regular version of the program, a version which may be offered to the user free of charge, or alternative versions of the program, which versions may cost the user a predetermined amount of money to view. For example, the user may select to play the commercial free version of program x for twenty-five cents by navigating a highlight region to play element 2120.

FIG. 21B is a display screen showing an alternative business model for providing programming in accordance with an embodiment of the invention. Display screen 2130 shows a screen for a pay-per-view event that permits a user to select from regular and alterative versions of the pay-per-view event. For example, as shown, a user may select from one of versions 2132, 2134, or 2136. The user may select version 2132 to watch the highlights of the program, version 2134 to watch just the program, or version 2136 to watch the program and additional material associated with the program.

It is understood that other business models not specifically mentioned herein may be practiced by the invention.

Accordingly, what have been described thus far are systems and methods for accessing media programs and media program options based on a user's interest in media program segments. When a user selects a media program for access or recording, a program option circuit can present options related to the selected media program if media program conditions associated with the options are satisfied. A segment tune-in timer circuit can track user interest in media program segments and can maintain the interest information in a segment interest table.

In one aspect of the invention, the embodiments and aspects of the invention described above herein can be implemented in an interactive media guidance system, which will now be described in connection with FIGS. 22-27.

An illustrative interactive media guidance system 2200 in accordance with the present invention is shown in FIG. 22. System 2200 is intended to illustrate a number of approaches by which media of various types, and guidance for such media, may be provided to (and accessed by) end-users. The present invention, however, may be applied in systems employing any one or a subset of these approaches, or in systems employing other approaches for delivering media and providing media guidance.

The first approach represents a typical television-centric system in which users may access television (and in some systems music) programming. This includes programming sources 2202 and distribution facility 2204. Media such as television programming and digital music is provided from programming sources 2202 to distribution facility 2204, using communications path 2206. Communications path 2206 may be a satellite path, a fiber-optic path, a cable path, or any other suitable wired or wireless communications path or combination of such paths.

Programming sources 2202 may be any suitable sources of television and music programming, such as television broadcasters (e.g., NBC, ABC, and HBO) or other television or music production studios. Programming sources 2202 may provide television programming in a variety of formats in high definition and standard definition, such as, for example, 1080p, 1080i, 720p, 480p, 480i, and any other suitable format.

Distribution facility 2204 may be a cable system headend, a satellite television distribution facility, a television broadcaster, or any other suitable facility for distributing video media (e.g., television programs, video-on-demand programs, pay-per-view programs) and audio media (e.g., music programming and music clips) to the equipment of subscribers of the corresponding cable, satellite, or IPTV system. In some approaches, distribution facility 2204 may also distribute other media to users, such as video and audio clips, web pages, and interactive applications, that may be offered to subscribers of a given cable, satellite, or IPTV system. There are typically numerous distribution facilities 2204 in system 2200, but only one is shown in FIG. 22 to avoid overcomplicating the drawing.

Distribution facility 2204 may be connected to various user equipment devices 2208, 2210, and 2212. Such user equipment devices may be located, for example, in the homes of users. User equipment devices may include user television equipment 2210, user computer equipment 2212, or any other type of user equipment suitable for accessing media. User equipment 2208 may be any type of user equipment (e.g., user television equipment, user computer equipment, cellular phones, handheld video players, gaming platforms, etc.), including mobile or portable television viewing devices, such as location-free television consumer electronic devices or car entertainment systems that include a television tuner. For simplicity, user equipment devices may be referred to generally as user equipment 2208.

User equipment devices 2208, 2210, and 2212 may receive media (such as television, music, web pages, etc.) and other data from distribution facility 2204 over communications paths, such as communications paths 2214, 2216, and 2218, respectively. User equipment devices 2208, 2210, 2212 may also transmit signals to distribution facility 2204 over paths 2214, 2216, and 2218, respectively. Paths 2214, 2216, and 2218 may be cables or other wired connections, free-space connections (e.g., for broadcast or other wireless signals), satellite links, or any other suitable link or combination of links.

A second approach illustrated in FIG. 22 by which media and media guidance are provided to end users is a non-television-centric approach. In this approach media such as video (which may include television programming), audio, images, web pages, or a suitable combination thereof, are provided to equipment of a plurality of users (e.g., user equipment 2208, user television equipment 2210, and user computer equipment 2212) by server 2230 via communications network 2226. This approach is non-television-centric because media (e.g., television programming) is provided by and delivered at least partially, and sometimes exclusively, via equipment that have not traditionally been primarily focused on the television viewing experience. Non-television-centric equipment is playing a larger role in the television viewing experience.

In some embodiments for this approach, communications network 2226 is the Internet. Server 2230 may provide for example, a web site that is accessible to the user's equipment and provides an on-line guidance application for the user. In such approaches, the user's equipment may be, for example, a PC or a hand-held device such as a PDA or web-enabled cellular telephone that incorporates a web browser. In other embodiments, server 2230 uses the Internet as a transmission medium but does not use the Web. In such approaches, the user's equipment may run a client application that enables the user to access media. In still other approaches, communications network 2226 is a private communications network, such as a cellular phone network, that does not include the Internet.

In yet other approaches, communications network 2226 includes a private communications network and the Internet. For example, a cellular telephone or other mobile-device service provider may provide Internet access to its subscribers via a private communications network, or may provide media such as video clips or television programs to its subscribers via the Internet and its own network.

The aforementioned approaches for providing media may, in some embodiments, be combined. For example, a distribution facility 2204 may provide a television-centric media delivery system, while also providing users' equipment (e.g., 2208, 2210 and 2212) with access to other non-television-centric delivery systems provided by server 2230. For example, a user's equipment may include a web-enabled set-top box or a television enabled PC. Distribution facility 2204 may, in addition to television and music programming, provide the user with Internet access whereby the user may access server 2230 via communications network 2226. Distribution facility 2204 may communicate with communications network 2226 over any suitable path 2234, such as a wired path, a cable path, fiber-optic path, satellite path, or combination of such paths.

Media guidance applications may be provided using any approach suitable for the type of media and distribution system for which the applications are used. Media guidance applications may be, for example, stand alone applications implemented on users' equipment. In other embodiments, media guidance applications may be client-server applications where only the client resides on the users' equipment. In still other embodiments, guidance applications may be provided as web sites accessed by a browser implemented on the users' equipment. Whatever the chosen implementation, the guidance application will require information about the media for which it is providing guidance. For example, titles or names of media, brief descriptions, or other information may be necessary to allow users to navigate among and find desired media selections. Additionally, the guidance application can have information on whether different versions of a media program are available for access by a user. In one embodiment, the guidance application can also maintain or have access to a segment interest table (e.g., FIGS. 14-16).

In some television-centric embodiments, for example, the guidance application may be a stand-alone interactive television program guide that receives program guide data via a data feed (e.g., a continuous feed, trickle feed, or data in the vertical blanking interval of a channel). Data source 2220 in system 2200 may include a program listings database that is used to provide the user with television program-related information such as scheduled broadcast times, titles, channels, ratings information (e.g., parental ratings and critic's ratings), user or community interest information (e.g., a segment interest table, FIGS. 14-16), detailed title descriptions, genre or category information (e.g., sports, news, movies, etc.), program format (e.g., standard definition, high definition) and information on actors and actresses. Data source 2220 may also be used to provide advertisements (e.g., program guide advertisements and advertisements for other interactive television applications), real-time data such as sports scores, stock quotes, news data, and weather data, application data for one or more media guidance applications or other interactive applications, and any other suitable data for use by system 2200. As another example, data source 2220 may provide data indicating the types of information that may be included in interactive media guidance overlays (e.g., at the request of the user, absent user modification, etc.).

Program guide data may be provided to user equipment, including user equipment located on home network 2213, using any suitable approach. For example, program schedule data, information on the availability of different version of media programs, various different versions of media programs, segment interest tables (e.g., FIG. 14-16), segment information metadata (e.g., FIG. 9), and other data may be provided to the user equipment on a television channel sideband, in the vertical blanking interval of a television channel, using an in-band digital signal, using an out-of-band digital signal, or by any other suitable data transmission technique. Program schedule data, media programs, different versions of media programs, and other data may be provided to user equipment on multiple analog or digital television channels. Program schedule data and other data (e.g., segment interest tables, FIGS. 14-16) may be provided to the user equipment with any suitable frequency (e.g., continuously, daily, in response to a request from user equipment, etc.).

In some television-centric embodiments, guidance data from data source 2220 may be provided to users' equipment using a client-server approach. For example, a guidance application client residing on the user's equipment may initiate sessions with server 2240 to obtain guidance data when needed. In some embodiments, the guidance application may initiate sessions with server 2240 via a home network server (e.g., a server located in home network 2213 that supports the user equipment devices located in home network 2213).

There may be multiple data sources (such as data source 2220) in system 2200, although only one data source is shown in FIG. 22 to avoid overcomplicating the drawing. For example, a separate data source may be associated with each of a plurality of television broadcasters and may provide data that is specific to those broadcasters (e.g., advertisements for future programming of the broadcasters, logo data for displaying broadcasters' logos in program guide display screens, different versions of media programs, segment interest tables, etc.). Data source 2220 and any other system components of FIG. 22 may be provided using equipment at one or more locations. Systems components are drawn as single boxes in FIG. 22 to avoid overcomplicating the drawings.

Data source 2220 may provide data to distribution facility 2204 over communications path 2222 for distribution to the associated user equipment and home network 2213 (discussed below) over paths 2214, 2216, 2218, and 2219 (e.g., when data source 2220 is located at a main facility). Communications path 2222 may be any suitable communications path such as a satellite communications path or other wireless path, a fiber-optic or other wired communications path, a path that supports Internet communications, or other suitable path or combination of such paths.

In some television-centric and non-television centric approaches, data source 2220 may provide guidance data directly to user equipment 2208 over path 2224, communications network 2226, and path 2228 (e.g., when data source 2220 is located at a facility such as one of programming sources 2202). In some embodiments of the present invention, data source 2220 may provide guidance data directly to user equipment located on home network 2213 (discussed below) over path 2224, communications network 2226, and path 2239 (e.g., when data source 2220 is located at a facility such as one of programming sources 2202). Paths 2224, 2228, and 2239 may be wired paths such as telephone lines, cable paths, fiber-optic paths, satellite paths, wireless paths, any other suitable paths or a combination of such paths. Communications network 2226 may be any suitable communications network, such as the Internet, the public switched telephone network, or a packet-based network.

User equipment devices, including user equipment devices located on home network 2213 (discussed below), such as user television equipment and personal computers, may use the program schedule data and other interactive media guidance application data to display program listings and other information (e.g., availability of different media program versions) for the user. An interactive television program guide application or other suitable interactive media guidance application may be used to display the information on the user's display (e.g., in one or more overlays that are displayed on top of video for a given television channel). Interactive displays (e.g., FIGS. 1, 5-7) may be generated and displayed for the user using any suitable approach. In one suitable approach, distribution facility 2204, server 2230, or another facility, may generate application display screens and may transmit the display screens to user equipment for display. In another suitable approach, user equipment may store data for use in one or more interactive displays (e.g., program schedule data, advertisements, logos, etc.), and an interactive media guidance application implemented at least partially on the user equipment may generate the interactive displays based on instructions received from distribution facility 2204, server 2230 or another facility. In some embodiments of the present invention, user equipment may store only the data that is used to generate the interactive television displays (e.g., storing logo data for a particular television broadcaster only if the logo is to be included in one or more interactive television displays). In some embodiments of the present invention, user equipment may store data that is not necessarily used to generate the interactive television displays (e.g., storing advertisements associated with a particular television broadcaster that may or may not be displayed depending on, for example, the outcome of negotiations with the television broadcaster). Any other suitable approach or combination of approaches may be used to generate and display interactive overlays for the user.

In still other embodiments, interactive media guidance applications (television-centric and non-television centric) may be provided online as, for example, websites. For example, server 2230 may provide an online interactive television program guide. As another example, user equipment 2208 may be a mobile device, such as a cellular telephone or personal digital assistant (PDA). The mobile device may be web-enabled to allow the user to access an on-line guidance application (which may be modified from its original version to make it appropriate for a cellular phone). Alternatively, the mobile device may have an applet that communicates with server 2230 to obtain guidance data via the Internet.

Server 2230 may receive program schedule data, information on the availability of different media program versions, segment interest tables (e.g., FIGS. 14-16), and other data from data source 2220 via communications path 2224, communications network 2226, and communications path 2232 or via another suitable path or combination of paths. Path 2232 may be a satellite path, fiber-optic path, wired path, or any other path or combination of paths. User equipment 2208 may access the on-line interactive media guidance application and other sources from server 2230 via communications path 2228. User equipment 2208 may also access the application and other services on server 2230 via communications path 2214, distribution facility 2204, and communications path 2234. For example, a cable modem or other suitable equipment may be used by user equipment 2208 to communicate with distribution facility 2204.

User equipment such as user television equipment 2210, user computer equipment 2212, and user equipment located on home network 2213 may access the on-line interactive media guidance application and server 2230 using similar arrangements. User television equipment 2210 may access the on-line interactive media guidance application and server 2230 using communications path 2236 or using path 2216, distribution facility 2204, and path 2234. User computer equipment 2212 may access the on-line interactive media guidance application and server 2230 using communications path 2238 or using path 2218, distribution facility 2204, and path 2234. User equipment located on home network 2213 may access the on-line media guidance application and server 2230 using communications path 2239 or using path 2219, distribution facility 2204, and path 2234. Paths 2236, 2238, and 2239 may be any suitable paths such as wired paths, cable paths, fiber-optic paths, wireless paths, satellite paths, or a combination of such paths.

In some embodiments, system 2200 may support other interactive applications in addition to the interactive media guidance applications. Such applications may be implemented using any suitable approach. For example, the interactive applications may be implemented locally on the user equipment or in a distributed fashion (e.g., using a client-server architecture in which the user equipment serves at least partly, and for at least some of the time, as the client and a server, such as server 2240 at distribution facility 2204, server 2230, or other suitable equipment acts as the server). Other distributed architectures may also be used if desired. Moreover, some or all of the features of the interactive applications of system 2200 (including the media guidance application) may be provided using operating system software or middleware software. Such operating system software and middleware may be used instead of or in combination with application-level software. In yet other approaches, interactive applications may also be supported by servers or other suitable equipment at one or more service providers such as service provider 2242. Regardless of the particular arrangement used, the software that supports these features may be referred to as an application or applications.

For example, an interactive application such as a home shopping service may be supported by a service provider such as service provider 2242 that has sales representatives, order fulfillment facilities, account maintenance facilities, and other equipment for supporting interactive home shopping features. A home shopping application that is implemented using the user equipment may be used to access the service provider to provide such features to the user. The user equipment may access service provider 2242 via distribution facility 2204 and communications path 2244 or via communications network 2226 and communications path 2246. Communications paths such as paths 2244 and 2246 may be any suitable paths such as wired paths, cable paths, fiber-optic paths, satellite paths, or a combination of such paths.

Another example of an interactive application is a home banking application. A home banking service may be supported using personnel at facilities such as service provider 2242. An interactive home banking application that is implemented using the user equipment may access the home banking service via distribution facility 2204 and communications path 2244 or via communications network 2226 and communications path 2246.

If desired, an interactive media guidance application such as a network-based video recorder or a video-on-demand application may be supported using server 2240, server 2230, a home network server, or equipment at service provider 2242. Video-on-demand content, different versions of media programs, and video recorded using a network-based video recorder arrangement may be stored on server 2240 or server 2230 or a home network server or at service provider 2242 and may be provided to the user equipment when requested by users. An interactive television program guide, for example, may be used to support the functions of a digital video recorder (sometimes called a personal video recorder) that is implemented using user equipment 2208. Illustrative equipment that may be used to support digital video recorder functions include specialized digital video recorder devices, integrated receiver decoders (IRDs), set-top boxes with integrated or external hard drives, or personal computers with video recording capabilities.

Interactive applications such as media guidance applications (e.g., interactive television program guide applications and video-on-demand applications), home shopping applications, home banking applications, game applications, and other applications (e.g., applications related to e-mail and chat or other communications functions, etc.) may be provided as separate applications that are accessed through a navigation shell application (i.e., a menu application with menu options corresponding to the applications). The features of such applications may be combined. For example, games, video-on-demand services, home shopping services, network-based video recorder functions, digital video recorder functions, navigational functions, program guide functions, communications functions, and other suitable functions may be provided using one application or any other suitable number of applications. The one or more applications may display various overlays on user equipment including, for example, interactive television information on top of video for a given television channel.

Interactive television program guide applications, home banking applications, home shopping applications, network-based video recorder and digital video recorder applications, video-on-demand applications, gaming applications, communications applications, and navigational applications are only a few illustrative examples of the types of interactive media guidance and other applications that may be supported by system 2200. Other suitable interactive applications that may be supported include news services, web browsing and other Internet services, and interactive wagering services (e.g., for wagering on horse races, sporting events, and the like). Interactive television overlays that are displayed by these applications may also be customized in accordance with the present invention.

Users may have multiple types of user equipment by which they access media and obtain media guidance. For example, some users may have home networks that are accessed by in-home and mobile devices. As shown in FIG. 22, home network 2213 communicates with distribution facility 2204 and server 2230 over paths 2219 and 2239 (and, in the case of server 2230, communications network 2226). Such home networks 2213 may be located, for example, in homes of users or distributed, for example, among homes of users. Home networks 2213 may each include a plurality of interconnected user equipment devices, such as, for example user equipment devices 2208, 2210 and 2212. In some embodiments, users may control in-home devices via a media guidance application implemented on a remote device. For example, users may access an online media guidance application on a website via a personal computer at their office, or a mobile device such as a PDA or web-enabled cellular telephone. The user may set settings (e.g., recordings, reminders, options to access different media program versions, or other settings) on the on-line guidance application to control the user's in-home equipment. The on-line guide may control the user's equipment directly, or by communicating with a media guidance application on the user's in-home equipment.

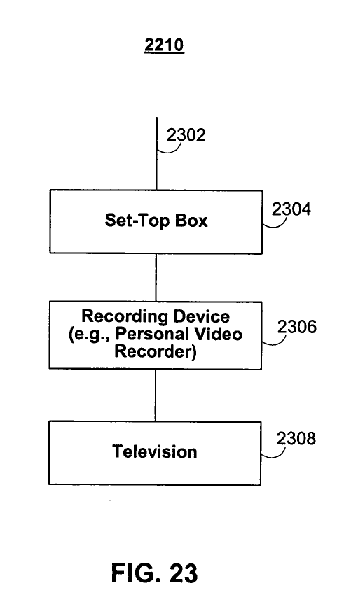

FIGS. 22-26 show illustrative arrangements for user equipment. An illustrative set-top box-based arrangement for user equipment 2210 is shown in FIG. 23. User television equipment 2210 may be stand-alone or a part of home network 2213 (FIG. 22). Input/output 2302 may be connected to communications paths such as paths 2216 and 2236 (FIG. 22). Input/output functions may be provided by one or more wires or communications paths, but are shown as a single path in FIG. 23 to avoid overcomplicating the drawing. Television programming, program guide data, information on the availability of different versions of media programs, various versions of media programs, segment interest tables, and any other suitable interactive media guidance application data or other data may be received using input/output 2302. Commands and requests and other data generated as a result of user interactions with the interactive media guidance application may also be transmitted over input/output 2302.

Set-top box 2304 may be any suitable analog or digital set-top box (e.g., a cable set-top box). Set-top box 2304 may contain an analog tuner for tuning to a desired analog television channel (e.g., a channel comprising television programming, interactive television data, or both). Set-top box 2304 may also contain digital decoding circuitry for receiving digital television channels (e.g., channels comprising television or music programming, interactive television data, etc.). Set-top box 2304 may also contain a high-definition television tuner for receiving and processing high-definition television channels. Set-top box 2304 may include a segment tune-in timer circuit (FIG. 10) and a program options circuit (FIG. 17). Analog, digital, and high-definition channels may be handled together if desired. Multiple tuners may be provided (e.g., to handle simultaneous watch and record functions or picture-in-picture (PIP) functions). Box 2304 may be an integrated receiver decoder (IRD) that handles satellite television. If desired, box 2304 may have circuitry for handling cable, over-the-air broadcast, and satellite content.

Set-top box 2304 may be configured to output media, such as television programs, in a preferred format. Because television programs may be received in a variety of formats, set-top box 2304 may contain scaler circuitry for upconverting and downconverting television programs into the preferred output format used by set-top box 2304. For example, set-top box 2304 may be configured to output television programs in 720p. In this example, the scaler circuitry may upconvert standard-definition television programs having 480 lines of vertical resolution to 720p format and downconvert certain high-definition television programs having 1080 lines of vertical resolution to 720p format.

Box 2304 may include a storage device (e.g., a digital storage device such as a hard disk drive) for providing recording capabilities. Box 2304 may also be connected to a recording device 2306 such as a video cassette recorder, digital video recorder, optical disc recorder, or other device or devices with storage capabilities. In some embodiments, box 2304 may be configured to record either standard-definition television programs or high-definition television programs. In some embodiments, box 2304 may be configured to record both standard-definition television programs and high-definition television programs.

Set-top box 2304 contains a processor (e.g., a microcontroller or microprocessor or the like) that is used to execute software applications. Set-top box 2304 may contain memory such as random-access memory for use when executing applications. Nonvolatile memory may also be used (e.g., to launch a boot-up routine and other instructions). Hard disk storage in box 2304 or in recording device 2306 may be used to back up data and to otherwise support larger databases and storage requirements than may be supported using random-access memory approaches. Hard disk storage in box 2304 or in recording device 2306 may also be used to store and back up program guide settings, segment interest tables (e.g., FIGS. 14-16), different versions of media programs, or saved user preferences.

Set-top box 2304 may have infrared (IR) or other communications circuitry for communicating with a remote control or wireless keyboard. Set-top box 2304 may also have dedicated buttons and a front-panel display. The front-panel display may, for example, be used to display the current channel to which the set-top box is tuned.

Set-top box 2304 may also have communications circuitry such as a cable modem, an integrated services digital network (ISDN) modem, a digital subscriber line (DSL) modem, a telephone modem, or a wireless modem for communications with other equipment. Such communications may involve the Internet or any other suitable communications networks or paths. If desired, the components of set-top box 2304 may be integrated into other user equipment (e.g., a television or video recorder).

Recording device 2306 may be used to record videos, media programs, or different versions of media programs provided by set-top box 2304. For example, if set-top box 2304 is tuned to a given television channel, the video signal for that television channel may be passed to recording device 2306 for recording on a videocassette, compact disc, digital video disk, or internal hard drive or other storage device. In some embodiments, recording device 2306 may be configured to record either standard-definition television programs or high-definition television programs. In some embodiments, recording device 2306 may be configured to record both standard-definition television programs and high-definition television programs. Recording device 2306 may have communications circuitry such as a cable modem, an ISDN modem, a DSL modem, or a telephone modem for communications with other equipment. Such communications may involve the Internet or any other suitable communications networks or paths. The components of recording device 2306 may be integrated into other user equipment (e.g., a television, stereo equipment, etc.).

Recording device 2306 may be controlled using a remote control or other suitable user interface. If desired, video recorder functions such as start, stop, record and other functions for device 2306 may be controlled by set-top box 2304. For example, set-top box 2304 may control recording device 2306 using infrared commands directed toward the remote control inputs of recording device 2306 or set-top box 2304 may control recording device 2306 using other wired or wireless communications paths between box 2304 and device 2306.

The output of recording device 2306 may be provided to television 2308 for display to the user. In some embodiments, television 2308 may be capable of displaying high-definition programming (i.e., HDTV-capable). If desired, multiple recording devices 2306 or no recording device 2306 may be used. If recording device 2306 is not present or is not being actively used, the video signals from set-top box 2304 may be provided directly to television 2308. Any suitable television or monitor may be used to display the video. For example, if the video is in a high-definition format, an HDTV-capable television or monitor is required to display the video. In the equipment of FIG. 23 and the other equipment of system 2200 (FIG. 22), the audio associated with various video items is typically distributed with those video items and is generally played back to the user as the videos are played. In some embodiments, the audio may be distributed to a receiver (not shown), which processes and outputs the audio via external speakers (not shown).

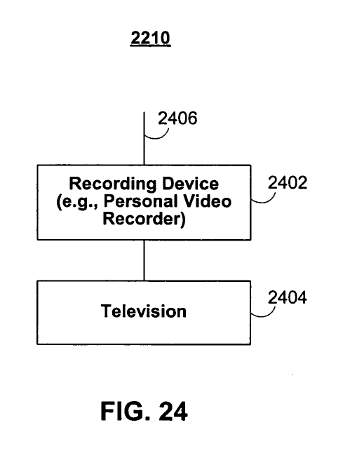

Another illustrative arrangement for user television equipment 2210 (FIG. 22) is shown in FIG. 24. User television equipment 2210 may be stand-alone or a part of home network 2213 (FIG. 22). In the example of FIG. 24, user television equipment 2210 includes a recording device 2402 such as a digital video recorder (e.g., a personal video recorder (PVR)) that uses a hard disk or other storage for recording video. Recording device 2402 may alternatively be a digital video disc recorder, compact disc recorder, videocassette recorder, or other suitable recording device. Equipment 2210 of FIG. 24 may also include a television 2404. In some embodiments, television 2404 may be HDTV-capable. Input/output 2406 may be connected to communications paths such as paths 2216 and 2236 (FIG. 22). Television programming, program schedule data, information on the availability of different versions of media programs, various versions of media programs, segment interest tables, and other data (e.g., advertisement data, data indicating one or more television channels for which the display of an overlay is to be customized, etc.) may be received using input/output 2406. Commands and requests and other data from the user may be transmitted over input/output 2406.

Recording device 2402 may contain at least one analog tuner for tuning to a desired analog television channel (e.g., to display video for a given television channel to a user, to receive program guide data and other data) and multiple other tuners may also be provided. Recording device 2402 may also contain digital decoding circuitry for receiving digital television programming, music programming, program guide data, and other data on one or more digital channels. Recording device 2402 may also contain circuitry for receiving high-definition television channels. If desired, recording device 2402 may contain circuitry for handling analog, digital, and high-definition channels. Recording device 2402 may include a segment tune-in timer circuit (FIG. 10) and a program options circuit (FIG. 17). Recording device 2402 also contains a processor (e.g., a microcontroller or microprocessor or the like) that is used to execute software applications. Recording device 2402 may contain memory such as random-access memory for use when executing applications. Nonvolatile memory may also be used to store a boot-up routine or other instructions. The hard disk and other storage in recording device 2402 may be used to support databases (e.g., program guide databases, segment interest tables, or other interactive television application databases). The hard disk or other storage in recording device 2402 may also be used to record video such as television programs, different versions of media programs, or video-on-demand content or other content provided to recording device 2402 over input/output 2406.

Recording device 2402 may have IR communications circuitry or other suitable communications circuitry for communicating with a remote control. Recording device 2402 may also have dedicated buttons and a front-panel display. The front-panel display may, for example, be used to display the current channel to which the recording device is tuned.

Recording device 2402 may also have communications circuitry such as a cable modem, an ISDN modem, a DSL modem, a telephone modem, or a wireless modem for communications with other equipment. Such communications may involve the Internet or other suitable communications networks or paths.

If desired, recording device 2402 may include a satellite receiver or other equipment that has wireless communications circuitry for receiving satellite signals.

Recording device 2402 of FIG. 24 or recording device 2306 of FIG. 23 may record new video while previously recorded video is being played back on television 2404 or 2308. This allows users to press a pause button during normal television viewing. When the pause button is pressed, the current television program is stored on the hard disk of digital video recorder 2402. When the user presses play, the recorded video may be played back. This arrangement allows the user to seamlessly pause and resume television viewing. Recording devices 2402 and 2306 may also be used to allow a user to watch a previously-recorded program while simultaneously recording a new program.

The set-top box arrangement of FIG. 23 and the digital video recorder with a built-in set-top box arrangement of FIG. 24 are merely illustrative. Other arrangements may be used if desired. For example, user television equipment may be based on a WebTV box, a personal computer television (PC/TV), or any other suitable television equipment arrangement. If desired, the functions of components such as set-top box 2304, recording device 2402, a WebTV box, or PC/TV or the like may be integrated into a television or personal computer or other suitable device.

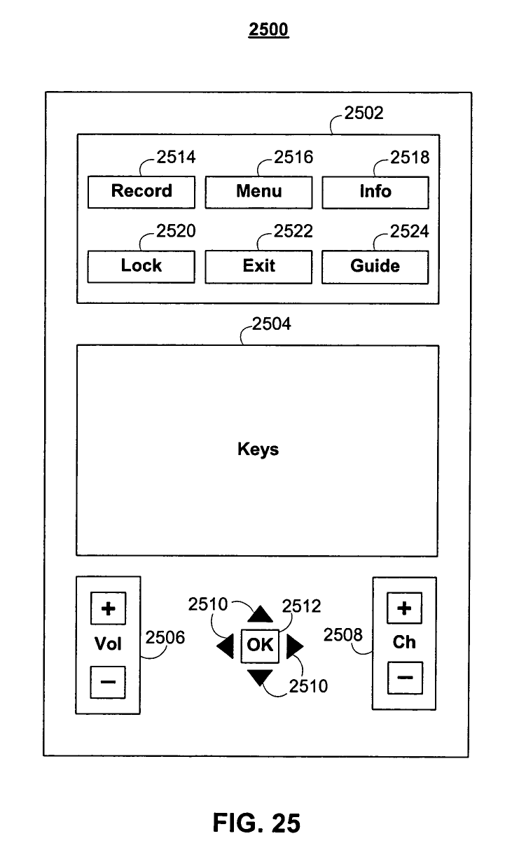

An illustrative remote control 2500 for operating user television equipment 2210 (FIG. 22) or suitable user computer equipment 2212 is shown in FIG. 25. Remote control 2500 is only illustrative and any other suitable user input interface may be used to operate user equipment (e.g., a mouse, trackball, keypad, keyboard, touch screen, voice recognition system, etc.). Remote control 2500 may have function keys 2502 and other keys 2504 such as keypad keys, power on/off keys, pause, stop, fast-forward and reverse keys. Volume up and down keys 2506 may be used for adjusting the volume of the audio portion of a video. Channel up and down keys 2508 may be used to change television channels and to access content on virtual channels. Cursor keys 2510 may be used to navigate on-screen menus. For example, cursor keys 2510 may be used to position an on-screen cursor, indicator, or highlight (sometimes all generically referred to herein as a highlight or highlight region) to indicate interest in a particular option or other item on a display screen that is displayed by the interactive television application.

OK key 2512 (sometimes called a select or enter key) may be used to select on-screen options that the user has highlighted, such as options to access different versions of media programs (FIGS. 5-7).

Keys 2502 may include RECORD key 2514 for initiating recordings. MENU button 2516 may be used to direct an interactive media guidance application to display a menu on the user's display screen (e.g., on television 2308 or 2404 or on a suitable monitor or computer display). INFO button 2518 may be used to direct an interactive media guidance application to display an information display screen. For example, when a user presses INFO key 2518 while video for a given television channel is displayed for the user, an interactive television program guide may display a FLIP/BROWSE overlay including program schedule information for the current program on the given television channel on top of the video. As another example, when a particular program listing in an interactive television program listings display screen is highlighted, the user pressing INFO button 2518 may cause an interactive television program guide to provide additional program information associated with that program listing (e.g., a program description, actor information, schedule information, etc.).

LOCK button 2520 may be used to modify access privileges. For example, a parent may use LOCK button 2520 or on-screen options to establish parental control settings for the interactive media guidance application. The parental control settings may be time-based settings (e.g., to prevent a child from watching television during a particular time block, such as from 3:00 PM to 5:00 PM). The parental control settings may also be used to, for example, block programming based on rating, channel, and program title. A locked or blocked program (or other media) is typically not viewable until the interactive media guidance application is provided with a suitable personal identification number (PIN). Once this PIN has been entered, the interactive media guidance application will unlock the user's equipment and allow the locked content to be accessed.

EXIT button 2522 may be used to exit the interactive media guidance application or to exit a portion of the interactive media guidance application (e.g., to cause an interactive television program guide to remove a FLIP, BROWSE, or other interactive television overlay from the display screen). GUIDE button 2524 may be used to invoke an interactive television program guide (e.g., a program guide menu screen, program listings screen, or other program guide screen).

The keys shown in FIG. 25 are merely illustrative. Other keys or buttons may be provided if desired. For example, a music button may be used to access music with the interactive media guidance application. An edit button may be used to edit stored content (e.g., to remove commercials, remove portions of a video, etc.). Alphanumeric buttons may be used to enter alphanumeric characters. A last or back button may be used to browse backward in the interactive media guidance application (e.g., to return to a previous channel, web page, or other display screen). Video recorder function buttons such as a play button, pause button, stop button, rewind button, fast-forward button, and record button, may be used to control video recorder functions (local or network-based) in system 2200 (FIG. 22). A help key may be used to invoke help functions such as context-sensitive on-screen help functions.

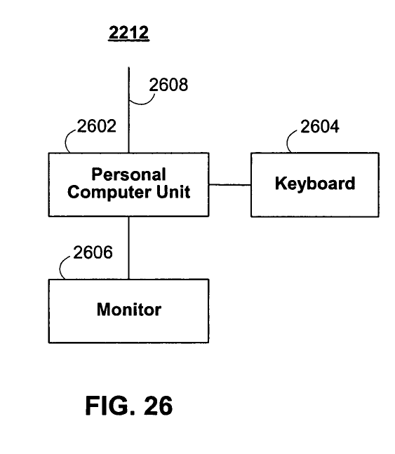

Illustrative user computer equipment 2212 (FIG. 22) is shown in FIG. 26. User computer equipment 2212 may be stand-alone or a part of home network 2213 (FIG. 22). In the arrangement of FIG. 26, personal computer unit 2602 may be controlled by the user using keyboard 2604 and/or other suitable user input device such as a trackball, mouse, touch pad, touch screen, voice recognition system, or a remote control, such as remote control 2500 of FIG. 25. Video content, such as television programming or web pages having video elements, and interactive media guidance application display screens may be displayed on monitor 2606. Television and music programming, media guidance application data (e.g., television program guide data), video-on-demand content, video recordings played back from a network-based video recorder, information on the availability of different versions of media programs, various versions of media programs, segment interest tables, and other data may be received from paths 2218 and 2238 (FIG. 22) using input/output 2608. User commands and other information generated as a result of user interactions with the interactive media guidance application and system 2200 (FIG. 22) may also be transmitted over input/output 2608.

Personal computer unit 2602 may contain a television or video card, such as a television tuner card, for decoding analog, digital, and high-definition television channels and for handling streaming video content. Multiple video cards (e.g., tuner cards) may be provided if desired. An illustrative television tuner card that may be used may contain an analog television tuner for tuning to a given analog channel, digital decoding circuitry for filtering out a desired digital television or music channel from a packetized digital data stream, and a high-definition television tuner for tuning to a high-definition channel. Any suitable card or components in computer unit 2602 may be used to handle video and other content delivered via input/output line 2608 if desired.

Personal computer unit 2602 may contain one or more processors (e.g., microprocessors) that are used to run the interactive media guidance application or a portion of the interactive media guidance application.

Personal computer unit 2602 may include a hard drive, a recordable DVD drive, a recordable CD drive, or other suitable storage device or devices that stores video, program guide data, information on the availability of different versions of media programs, various versions of media programs, segment interest tables, and other content. The interactive media guidance application and personal computer unit 2602 may use a storage device or devices to, for example, provide the functions of a digital video recorder. The personal computer unit 2602 may include a segment tune-in timer circuit (FIG. 10) and a program options circuit (FIG. 17).

User equipment, such as user equipment 2208, user television equipment 2210, user computer equipment 2212, and user equipment located on home network 2213 (FIG. 22), may be used with network equipment such as server 2230, server 2240, a home network server, and equipment at service providers such as service provider 2242 of FIG. 22 to provide network-based video recording functions. Video recording functions may be provided by storing copies of television programs and other video content on a remote server (e.g., server 2230 or server 2240 or a home network server) or other network-based equipment, such as equipment at a service provider such as service provider 2242.

Video recordings may be made in response to user commands that are entered at user equipment 2208 or user equipment located on home network 2213 (FIG. 22). In a digital video recorder arrangement, the interactive media guidance application may be used to record video locally on the user equipment in response to the user commands. In a network-based video recorder arrangement, the interactive media guidance application may be used to record video or to make virtual recordings (described below) on network equipment such as server 2230, server 2240, a home network server, or equipment at service provider 2242 in response to the user commands. The user commands may be provided to the network equipment over the communications paths shown in FIG. 22. The digital video recorder arrangement and the network-based video recorder arrangement can support functions such as fast-forward, rewind, pause, play, and record.

To avoid unnecessary duplication in a network-based video recorder environment, system 2200 may provide network-based video recording capabilities by using virtual copies or recordings. With this approach, each user may be provided with a personal area on the network that contains a list of that user's recordings. The video content need only be stored once (or a relatively small number of times) on the network equipment, even though a large number of users may have that video content listed as one of their recordings in their network-based video recorder personal area. Personal settings or any other suitable data may be stored in a user's personal area on the network.

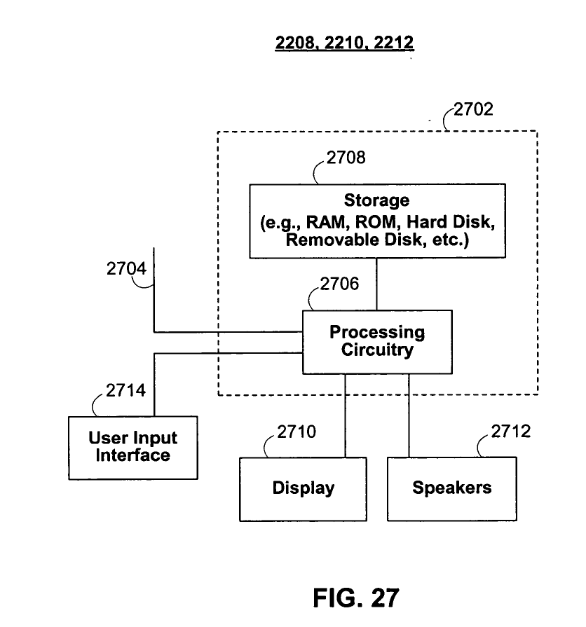

The user television equipment and user computer equipment arrangements described above are merely illustrative. A more generalized embodiment of illustrative user equipment 2208, 2210, and 2212 (FIG. 22) and user equipment located on home network 2213 (FIG. 22) is shown in FIG. 27, which can include mobile or portable television viewing devices, such as location-free television consumer electronic devices or car entertainment systems that include a television tuner. Control circuitry 2702 is connected to input/output 2704. Input/output 2704 may be connected to one or more communications paths such as paths 2214, 2216, 2218, 2228, 2236, and 2238 of FIG. 22. Media (e.g., television programming, music programming, different versions of media programs, other video and audio, and web pages) may be received via input/output 2704 (e.g., from programming sources 2202, servers or other equipment, such as server 2230, service providers such as service provider 2242, distribution facility 2204, etc.). Interactive media guidance application data, such as program schedule information for an interactive television program guide, information on the availability of different versions of media programs, various versions of media programs, and segment interest tables may be received from data source 2220 via input/output 2704. Input/output 2704 may also be used to receive data from data source 2220 for other interactive television applications. The user may use control circuitry 2702 to send and receive commands, requests, and other suitable data using input/output 2704.

Control circuitry 2702 may be based on any suitable processing circuitry 2706 such as processing circuitry based on one or more microprocessors, microcontrollers, digital signal processors, programmable logic devices, etc. In some embodiments, control circuitry 2702 executes instructions for an interactive media guidance application or other interactive application (e.g., web browser) from memory. Memory (e.g., random-access memory and read-only memory), hard drives, optical drives, or any other suitable memory or storage devices may be provided as storage 2708 that is part of control circuitry 2702. Tuning circuitry such as one or more analog tuners, one or more MPEG-2 decoders or other digital video circuitry, high-definition tuners, or any other suitable tuning or video circuits or combinations of such circuits may also be included as part of circuitry 2702. Encoding circuitry (e.g., for converting over-the-air, analog, or digital signals to MPEG signals for storage) may also be provided. The tuning and encoding circuitry may be used by the user equipment to receive and display, play, or record a particular television or music channel or other desired audio and video content (e.g., video-on-demand content or requested network-based or local video recorder playback). The control circuit 2702 may include a segment tune-in timer circuit (FIG. 10) and a program options circuit (FIG. 17). Television programming and other video and on-screen options and information may be displayed on display 2710. Display 2710 may be a monitor, a television, or any other suitable equipment for displaying visual images. In some embodiments, display 2710 may be HDTV-capable. Speakers 2712 may be provided as part of a television or may be stand-alone units. Digital music and the audio component of videos displayed on display 2710 may be played through speakers 2712. In some embodiments, the audio may be distributed to a receiver (not shown), which processes and outputs the audio via speakers 2712.

A user may control the control circuitry 2702 using user input interface 2714. User input interface 2714 may be any suitable user interface, such as a mouse, trackball, keypad, keyboard, touch screen, touch pad, voice recognition interface, or a remote control.

Accordingly, what have been described thus far are systems and methods for presenting media programs based on a user's interest in media program segments. When a user selects a media program for access or recording, a program option circuit can present options related to the selected media program if media program conditions associated with the options are satisfied. A segment tune-in timer circuit can track user interest in media program segments and can maintain the interest information in a segment interest table. The disclosed embodiments and illustrations are exemplary and do not limit the scope of the disclosed invention as defined by the following claims.

What is claimed is:

1. A system for communicating at least one segment of interest from a media program, the system comprising:
a display screen that displays a media program having segments, wherein the segments are logical segments; and
a processor that is configured to allow a user to access particular segments of interest from the segments of a media program by:
identifying the segments of the media program,
receiving user input designating particular segments of interest from the segments of the media program, and
providing to the user only the designated segments of the media program.

2. The system of claim 1, wherein the segments of the media program are identified by metadata.

3. The system of claim 1, wherein the processor is configured to:
pre-designate particular segments from the segments of the media program based on information on interest in the segments of the media program, wherein the information is based on monitored interest; and
allowing a user to change the pre-designation of the segments of the media program.

4. The system of claim 3, wherein the information on interest in the segments of the media program is based on monitored interest in analogous segments of previous episodes of the media program.

5. The system of claim 3, wherein the information on interest in the segments of the media program is based on monitored interest in analogous segments of media programs other than previous episodes of the media program.

6. The system of claim 3, wherein the information on interest in the segments corresponds to at least one of: a single user's monitored interest, a community's monitored interest, a shorter-term monitored interest, and a longer-term monitored interest.

7. The system of claim 6, wherein the community corresponds to at least one of: a science fiction community, a family-oriented community, and a sports community.

8. The system of claim 1, further comprising a recording device that stores media programs, wherein the processor is configured to instruct the recording device to record the designated segments of interest.

9. A method for communicating at least one segment of interest from a media program, the method comprising:
identifying the segments of a media program, where the segments are logical segments;
receiving user input designating particular segments of interest from the segments of the media program; and
providing to the user only the designated segments of the media program.

10. The method of claim 9, wherein the segments of the media program are identified by metadata.

11. The method of claim 9, further comprising:
pre-designating particular segments from the segments of the media program based on information on interest in the segments of the media program, wherein the information is based on monitored interest; and
allowing a user to change the pre-designation of the segments of the media program.

12. The method of claim 11, wherein the information on interest in the segments of the media program is based on monitored interest in analogous segments of previous episodes of the media program.

13. The method of claim 11, wherein the information on interest in the segments of the media program is based on monitored interest in analogous segments of media programs other than previous episodes of the media program.

14. The method of claim 11, wherein the information on interest in the segments corresponds to at least one of: a single user's monitored interest, a community's monitored interest, a shorter-term monitored interest, and a longer-term monitored interest.

15. The method of claim 14, wherein the community corresponds to at least one of: a science fiction community, a family-oriented community, and a sports community.

16. The method of claim 9, further comprising recording the designated segments of interest.

17. A method for communicating at least one segment of interest from a media program, wherein the media program is accessed through an interactive program guide, the method comprising:
identifying the segments of a media program, where the segments are logical segments;
receiving user input designating particular segments of interest from the segments of the media program; and
providing to the user only the designated segments of the media program.
